(19) United States
(12) Patent Application Publication
(10) Pub. No.: US 2017/0064412 A1
(43) Pub. Date: Mar. 2, 2017

(54) DEVICE-BASED EVENT DETECTION AND NOTIFICATION SURFACING

(71) Applicant: Echostar Technologies, LLC, Englewood, CO (US)

(72) Inventor: Karen Taxier, Highlands Ranch, CO (US)

(73) Assignee: ECHOSTAR TECHNOLOGIES, LLC, Englewood, CO (US)

(21) Appl. No.: 14/837,591

(22) Filed: Aug. 27, 2015

(51) Int. Cl. H04N 21/81; H04L 29/08; H04N 21/44; H04N 21/24; H04N 21/478; H04N 21/41; H04N 21/234; H04L 12/28; H04N 21/61

(52) U.S. Cl. CPC H04N 21/8133; H04L 12/2823; H04L 67/12; H04N 21/44008; H04N 21/6143; H04N 21/478; H04N 21/4131; H04N 21/812; H04N 21/23418; H04N 21/2407

(57) ABSTRACT

Embodiments described herein provide various techniques for surfacing event notifications within home automation systems and other location monitoring systems. In some embodiments, event notification detection and display systems may be implemented and configured to communicate with various sensor devices and receive sensor data corresponding to home automation events. Such systems may include specialized hardware and/or software components configured to initiate event notifications, determine notification priority levels, and determine one or more associated display devices on which to output event notifications. In some cases, initial notifications may be output immediately in response to the detection of an event at one or more sensor devices. Additionally or alternatively, delayed notifications may be output at a later time in response to detected changes in the content being displayed at display devices.

### BACKGROUND OF THE INVENTION

Sensor-based and device-based control and monitoring systems are often designed for a limited and specific control or monitoring functions. Such specificity may limit system flexibility and usability. Further, such systems may be difficult to manage and configure, and may rely on proprietary non-intuitive interfaces and/or keypads. Accordingly, users wishing to deploy different control and monitoring tasks in their homes and other monitoring locations may be required to deploy multiple systems, each designed for a specific task and each with a separate control and configuration interface.

### BRIEF SUMMARY OF THE INVENTION

Aspects described herein provide various techniques for determining, generating, and surfacing event notifications within home automation systems and other location monitoring systems. In some embodiments, event notification detection and display systems may be implemented and configured to communicate with various sensor devices and receive sensor data corresponding to home automation events. Such systems may include specialized hardware and/or software components configured to initiate event notifications, determine notification priority levels, and determine one or more associated display devices on which to output event notifications. In some cases, initial notifications may be output immediately in response to the detection of an event at one or more sensor devices. Additionally or alternatively, delayed notifications may be output at a later time in response to detected changes in the content being displayed at display devices. For example, an event notification detection and display system may detect a high-priority event, and output an initial notification via a display device that is actively displaying content. The system may receive a user response requesting a follow-up notification, and then may generate and output a delayed notification in response to the detection of a change in the content being displayed on the display device.

According to additional techniques described herein, configuration interfaces may be provided to allow configuration of various aspects of the determination, generation, and surfacing of event notifications. For example, priority levels for event notifications may be pre-configured and/or user-customizable based on which sensor devices detected the events, the time and date of the event detections, the user(s) to which the events notifications are output, the states of other devices in a home automation system, and the like. The times and durations of initial notifications and delayed notifications also may be configurable in certain embodiments, along with the specific users and specific display devices to which the notifications may be output.

### BRIEF DESCRIPTION OF THE DRAWINGS

The present invention is described in conjunction with the appended figures:

FIG. 1 is a block diagram illustrating an embodiment of an event notification detection and display system, according to one or more embodiments of the disclosure.

FIG. 2 is a block diagram illustrating an example satellite television system, according to one or more embodiments of the disclosure.

FIG. 3 is a block diagram illustrating an example television receiver device, according to one or more embodiments of the disclosure.

FIG. 4 is a block diagram illustrating a home automation system, according to one or more embodiments of the disclosure.

FIG. 5 is a flow diagram illustrating an example process of generating and outputting initial notifications and follow-up notifications, according to one or more embodiments of the disclosure.

FIG. 6 illustrates an example timeline for surfacing home automation-related event notifications to users via one or more display devices, according to embodiments of the disclosure.

FIG. 7 is a flow diagram illustrating an example process of analyzing sensor data and generating initial and delayed notifications via display devices, according to one or more embodiments of the disclosure.

FIGS. 8A and 8B are illustrative user interface screens used to configure event notification detection and display functionality within a home automation system, according to one or more embodiments of the disclosure.

FIG. 9 is a block diagram illustrating an example computing system upon which various features of the present disclosure may be implemented.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

Various techniques (e.g., systems, methods, computer-program products tangibly embodied in a non-transitory computer-readable storage medium, etc.) are described herein for generating and surfacing event notifications within home automation systems and the like. Event notification detection and display systems may be implemented and configured to communicate with various sensor devices and receive sensor data corresponding to home automation events. Such systems may include specialized hardware and/or software components configured to initiate event notifications, determine notification priority levels, and determine one or more associated display devices on which to output event notifications. In certain embodiments, initial notifications may be output immediately in response to the detection of an event at one or more sensor devices. Additionally or alternatively, delayed notifications may be output at a later time in response to a detected change in the content being displayed at a display device. As an example, an event notification detection and display system may detect a high-priority event, and output an initial notification via a display device that is actively displaying content. The system may receive a user response requesting a follow-up notification, and then generate and output a delayed notification in response to the detection of a change in the content being displayed on the display device.

As described herein, various aspects of the determination, generation, and/or surfacing of event notifications may be configurable and customizable in certain embodiments. For example, priority levels for event notifications may be pre-configured and/or user-customizable based on which sensor devices detected the event, the time and date of the event detection, the user(s) to which the events notification is output, and/or the states of other devices in a home automation system (e.g., security system activation states), etc. The times and durations of initial notifications and delayed notifications also may be configurable and/or user-customizable in certain embodiments, along with the specific users and specific display devices to which the notifications may be output.

The various embodiments described herein may be implemented on and within one or more different networks and systems, including satellite or terrestrial television distribution systems, telecommunications network systems, computer networks such as the Internet, cellular and other mobile networking systems, and the like. Therefore, although certain examples below are described in terms of event notifications for home automation systems implemented via specific systems (e.g., satellite television distribution systems) and specific user equipment (e.g., television receivers, set-top boxes, remote controls, etc.), it should be understood that similar or identical embodiments may be implemented using other network systems and architectures (e.g., cable television networks, telecommunication networks, computer networks), as well as other user equipment and devices (e.g., servers, routers, firewalls, gaming consoles, personal computers, smartphones, etc.).

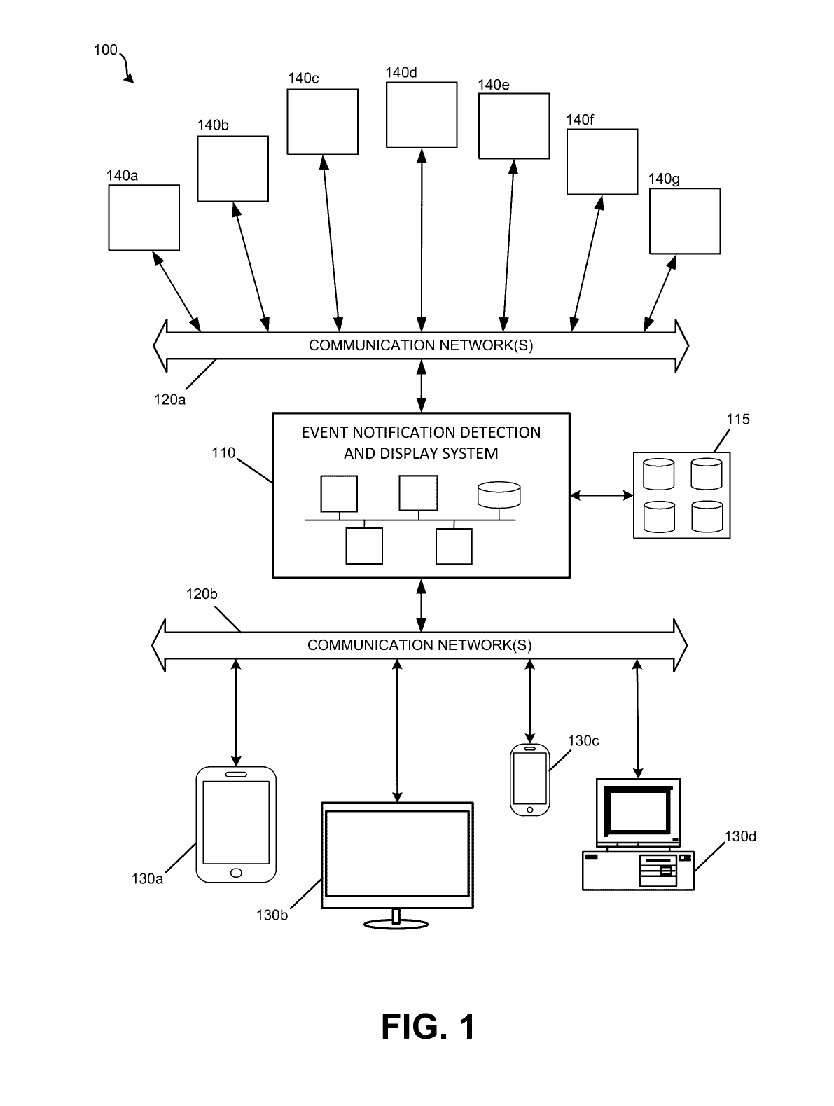

Referring now to FIG. 1, an example computing environment 100 is shown including an event notification detection and display system 110 configured to communicate with a plurality of sensor devices 140a-140g and a plurality of display devices 130a-130d. As discussed below, the event notification detection and display system 110 (or notification system 110, for brevity), and/or the additional devices and components within computing environment 100, may be implemented to receive and detect sensor data corresponding to events of a home automation system or other monitoring system, and then determine, generate, and output event notifications based on the detected sensor data. In order to perform these features and the additional functionality described below, each of the components and sub-components shown in example computing environment 100, such as notification system 110, sensor devices 140 and display devices 130, may correspond to a single computing device or server, or to a complex computing system including a combination of computing devices, storage devices, network components, etc. Each of these components and their respective subcomponents may be implemented in hardware, software, or a combination thereof. The components shown in environment 100 may communicate via communication networks 120, either directly or indirectly by way of various intermediary network components, such as satellite system components, telecommunication or cable network components, routers, gateways, firewalls, and the like. Although these physical network components have not been shown in this figure so as not to obscure the other elements depicted, it should be understood that any of the network hardware components and network architecture designs may be implemented in various embodiments to support communication between the sensor devices 140, notification system 110, display devices 130, and other components within this computing environment 100.

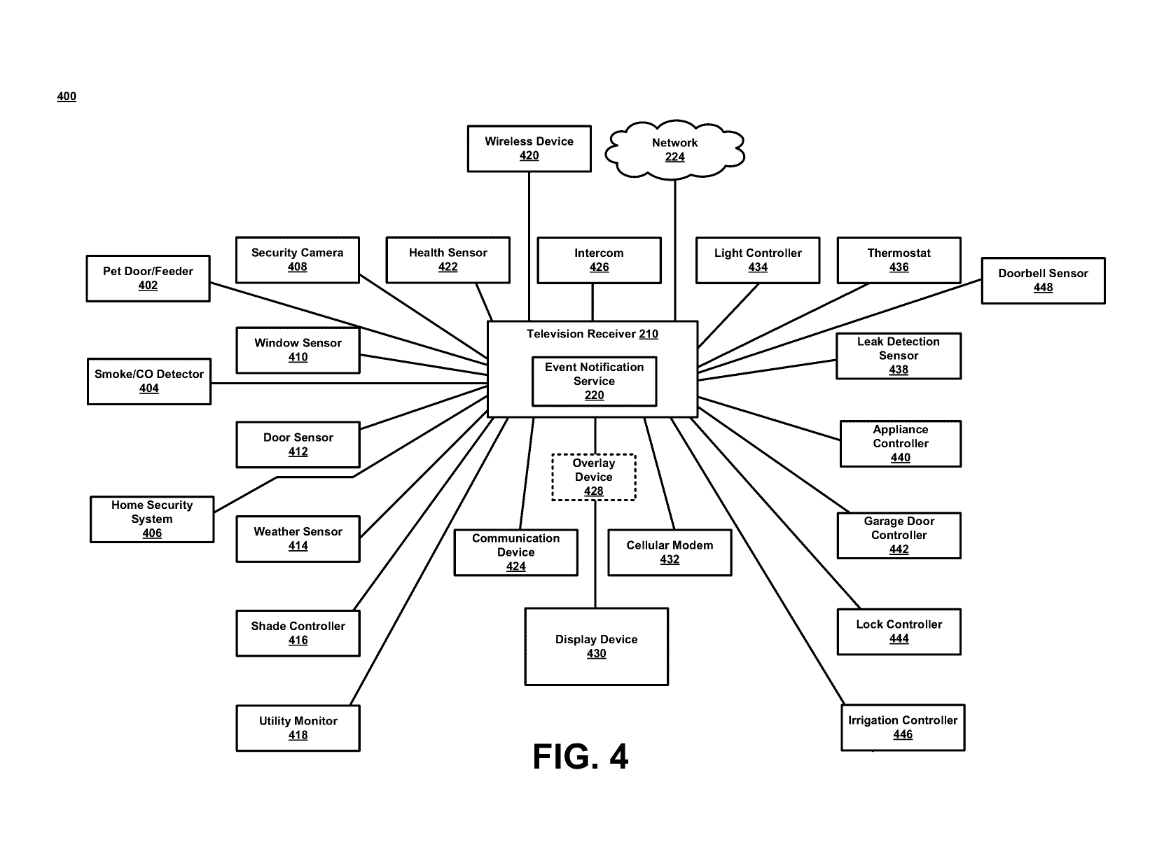

Sensor devices 140a-140g (which may be referred to collectively or individually as sensor device(s) 140) may include computer systems and other electronic devices configured to monitor conditions and physical locations and/or operational status of various electronic devices, and transmit the corresponding sensor data to one or more notification systems 110. For example, sensors devices 140 may include any or all of the in-home or on-residence home automation-related devices and systems 402-448 discussed below in reference to FIG. 4, such as security systems, home appliances, utility monitors, etc. Additionally, as discussed below, notification systems 110 need not be limited to use with home automation systems, but may be used in collaboration with other types of physical location monitoring systems, computer/electronic device status and control systems, and the like. In such cases, sensors devices 140 may include lights, office equipment, computer servers, mobile device-based sensors, vehicle-based sensors, etc. In any of these implementations, certain sensor devices 140 may include physical environment sensors such as cameras, microphones, power usage sensors, light sensors, water sensors, temperature sensors, movement sensors, and various other sensors capable of monitoring environmental conditions. Alternatively or additionally, sensor devices 140 may include circuitry and/or other physical interface components (e.g., analog circuits and/or digital or computer interfaces) to connect with and monitor the operational status of any electronic device. As used herein, “sensor data” may include data collected from physical environment sensors (e.g., cameras, microphones, power sensors, etc.), as well as data corresponding to the operational status of electronic devices.

Sensors devices 140 also may include network transmission capabilities, such as wireless transceivers (e.g., using WiFi, Bluetooth, NFC, cellular networks, or the like) and may be configured to transmit sensor data to one or more notification systems 110. Certain sensor devices 140 may be so-called “smart devices” including integrated device sensors and/or diagnostic capabilities, as well as network transmission capabilities. For example, a smart home appliance or network-enabled security system may be designed with integrated device monitoring and status transmission capabilities. During installation, such devices 140 may be paired with or otherwise configured to transmit sensor data (e.g., device status data, sensor readings, alerts and events, etc.) directly to the notification system 110 and/or other local network access points. Other sensor devices 140 might not be “smart” devices, but instead may be traditional household appliances or other legacy electronic devices that have been connect to or fitted an appliance monitor and/or controller device (see FIG. 4, 440) configured to monitor and transmit the operational status of the traditional or legacy device to the notification system 110.

Notification system 110 may be implemented as a single computing server, or a computing system including a combination of multiple computing devices, storage devices, network components, etc. In various embodiments, notification system 110 may include various specialized hardware and/or software components to perform device monitoring, data analysis, event generation and notification, and other functionality described herein. For example, notification system 110 may receive and/or process sensor data from sensor devices 140, and determine if and when event notifications should be generated and transmitted to display devices 130. In various embodiments, notification systems 110 may determine priority levels for notifications, and may determine associated display devices on which to output the notifications. Notification system 110 also may control the outputting of notifications via various display devices 130, along with the user response (if any) to notifications. As discussed below, in some cases initial notifications and/or delayed notifications may be provided, based on the priority level of the notification and user feedback received via the display devices 130. The notification system 110 also may provide one or more interfaces, including graphical user interfaces and/or programmatic interfaces (e.g., software services, application programming interfaces, etc.) to allow configuration and customization of event notifications, based on sensor devices 140, display devices 130, associate users, notification priority, event time and date, and the like. In such cases, notification system 110 may include one or more internal data stores and/or external data stores 115 (e.g., external storage systems, database servers, file-based storage, cloud storage systems, etc.) configured to store event definitions, user-event associations, user-device associations, and notification preferences such as notification times, devices, priority levels, and the like. In certain embodiments, data stores 115 may reside in a back-end server farm, storage cluster, and/or storage-area network (SAN).

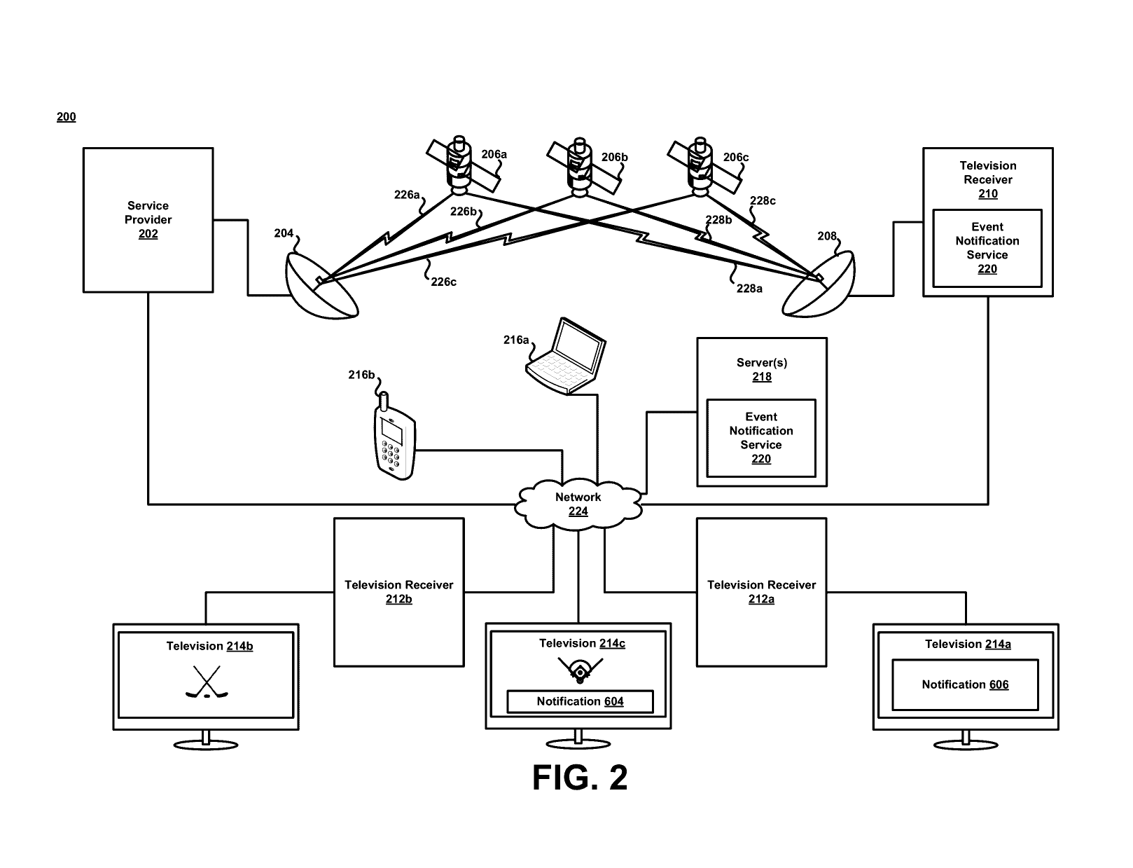

Although notification system 110 is illustrated as a standalone computer system in this example, as discussed below, it may be implemented within and/or integrated into one or more servers or devices of various content distribution systems and other computing architectures. For example, as discussed below in reference to FIGS. 2-4, notification system 110 may be implemented within a satellite television distribution system 200 and/or home automation 400. In such cases, the notification system 110 may be implemented as one or more event notification services (ENSs) within servers 218 and/or within television receivers 210 of the satellite television distribution system 200. In other embodiments, the notification system 110 may be implemented within other content distribution systems, such as terrestrial television distribution systems, video on demand systems, telecommunications network systems, LAN or WAN computer networks (e.g., the Internet), cellular and other mobile networking systems, and the like. In any of these examples, the notification system 110 may be implemented within (or integrated into) one or more content servers (e.g., satellite hubs, cable headends, Internet servers, etc.), one or more local computing devices (e.g., televisions, television receivers, set-top boxes, gaming consoles, standalone home monitoring stations, network routers, modems, personal computers, and the etc.), or a combination of server-side devices/services and local devices/services.

In any of these implementations, the notification system 110 may be configured to communicate with sensor devices 140 and display devices 130 over one or more communication networks 120, respectively to receive sensor data and output event notifications. As discussed below, in some embodiments display devices 130 may correspond to televisions and other television viewing devices (e.g., home computers, tablet computers, etc.). However, in other examples, display devices 130 may include any user device capable of displaying any digital image or video content. For instance, display devices 130 in various embodiments may include personal computers, laptops, smartphones, home monitoring/security display devices, weather station displays, digital picture frames, smartphones, smart watches, wearable computing devices, and/or vehicle-based display devices.

Each display device 130 may include hardware and software components to support a specific set of output capabilities (e.g., LCD display screen characteristics, screen size, color display, video driver, speakers, audio driver, graphics processor and drivers, etc.), and a specific set of input capabilities (e.g., keyboard, mouse, touchscreen, voice control, cameras, facial recognition, gesture recognition, etc.). Different display devices 130 may support different input and output capabilities, and thus different types of event notifications and user responses to event notifications may be compatible or incompatible with certain display devices 130. For example, certain event notifications generated and output by the notification system 110 may require specific types of processors, graphics components, and network components in order to be displayed (or displayed optimally) on a display device 130. Certain types of event notifications (e.g., large notifications, graphics-based notifications, high-definition image or video notifications, etc.) also may require specific output capabilities (e.g., LCD display screens, minimum screen sizes, color displays, video, audio, graphics, etc.). Additionally, different event notifications may include different interactive user response features that require various specific input capabilities for display devices 130, such as keyboards, mouses, touchscreens, voice control capabilities, gesture recognition, and the like. In some embodiments, the notification system 110 may customize the content of event notifications and/or the user response components based on the capabilities of the display device 130 selected to output the notification. Additionally, in some cases, users may establish user-specific preferences, which may be stored in data stores 115, for outputting specific types of event notifications on specific types of display devices 130.

The notification system 110, display devices 130, and sensor devices 140 each may include the necessary hardware and software components to establish network interfaces and transmit/receive sensor data, event notifications, user responses, indications of content display changes, etc. Some or all of these devices may include security features and/or specialized hardware (e.g., hardware-accelerated SSL and HTTPS, WS-Security, firewalls, etc.) in order to prevent hacking and other malicious access attempts within the computing environment 100. In some cases, notification system 110 may communicate with sensor devices 140 and/or display devices 130 using secure data transmission protocols and/or encryption for data transfers, for example, File Transfer Protocol (FTP), Secure File Transfer Protocol (SFTP), and/or Pretty Good Privacy (PGP) encryption. Service-based implementations of the notification system 110 may use, for example, the Secure Sockets Layer (SSL) or Transport Layer Security (TLS) protocol to provide secure connections between the notification system 110 and devices 130 and/or 140. SSL or TLS may use HTTP or HTTPS to provide authentication and confidentiality.

Communication network(s) 120, through which notification system 110 communicate with sensor devices 140 and/or display devices 130, may include local area networks (LANs), wide area networks (WANs) (e.g., the Internet), and/or various wireless telecommunications networks. For example, when a notification system 110 is implemented within a television receiver, wireless router, modem, or other local user equipment, then communication network 120a may include wireless local area networks (WLANs) or other short-range wireless technologies such as Bluetooth®, mobile radio-frequency identification (M-RFID), and/or other such communication protocols. In other examples, when at least a portion of a notification system 110 is implemented remotely at a central server, satellite hub, cable headend, or the like, then communication network 120a may include one or more WANs (e.g., the Internet), satellite communication networks, or terrestrial cable networks, and various cellular and/or telecommunication networks (e.g., 3G, 4G or EDGE (enhanced data rates for global evolution), WiFi (IEEE 802.11 family standards, or other mobile communication technologies), or any combination thereof. Similarly, when display devices 130 are local to the notification server 110, such as television receiver 110 or other residential network-enabled appliance 110 communicating with local televisions 130, home computers 130, and the like, then communication network 120b may include a WLAN and/or other short-range wireless technologies. In other examples, when display devices 130 are mobile devices and/or remote to notification server 110, such as television receiver 110 or other residential network-enabled appliance 110 communicating with smartphones 130, wearable devices 130, and display devices at other residences 130, then communication network 120b may include WANs, satellite networks, terrestrial cable networks, and/or cellular or other mobile telecommunication networks, etc.

As discussed above, notification system 110 may be implemented as a standalone hardware and software system, and may be implemented within one or more different computer network systems and architectures. For example, in reference to FIGS. 2-4, notification system 110 may be implemented as one or more event notification services 220 executing within server hardware 218 and/or television receiver devices 210 within a satellite television distribution system 200 and/or a home automation system 400. However, in other embodiments, notification system 110 may be incorporated within various different types of home monitoring systems and/or various different types of content distribution systems. For example, corresponding embodiments to those described in FIGS. 2-4 may be implemented within terrestrial cable television distribution systems, video on demand systems, telecommunications network systems, LAN or WAN computer networks (e.g., the Internet), cellular and other mobile networking systems, and the like. In any of these examples, a notification system 110 may be implemented within (or integrated into) one or more content servers (e.g., satellite hubs, cable headends, Internet servers, etc.), one or more local computing devices (e.g., televisions, television receivers, set-top boxes, gaming consoles, standalone home monitoring stations, network routers, modems, personal computers, and the etc.), or a combination of server-side devices/services and local devices/services. Thus, although not so limited, an appreciation of various aspects of the present disclosure may be gained from the following discussion in connection with FIGS. 2-4.

Referring now to FIG. 2, an example satellite television distribution system 200 is shown in accordance with the principles of the present disclosure. For brevity, the system 200 is depicted in a simplified form, and may include more or fewer systems, devices, networks, and/or other components as desired. Further, number and type of features or elements incorporated within the system 200 may or may not be implementation-specific, and at least some of the aspects of the system 200 may be similar to a cable television distribution system, an IPTV (Internet Protocol Television) content distribution system, and/or any other type of content distribution system.

The example system 200 may include a service provider 202, a satellite uplink 204, a plurality of satellites 206a-c, a satellite dish 208, a PTR (Primary Television Receiver) 210, a plurality of STRs (Secondary Television Receivers) 212a-b, a plurality of televisions 214a-c, a plurality of computing devices 216a-b, and at least one server 218 that may in general be associated with or operated by or implemented by the service provider 202. Additionally, the PTR 210 and/or the server 218 may include or otherwise exhibit an instance of an ENS (Event Notification Service) module 220. The ENS module 220 may be implemented and configured using various hardware and software components discussed above, in order to support the features and perform the functionality of the various notification systems 110 discussed above in reference to FIG. 1. Thus, one or more ENS modules 220 in this embodiment may be configured to generate and surface home automation-related event notifications to satellite television viewers.

The system 200 may further include at least one network 224 that establishes a bi-directional communication path for data transfer between and among each respective element of the system 200, outside or separate from the unidirectional satellite signaling path. The network 224 is intended to represent any number of terrestrial and/or non-terrestrial network features or elements. For example, the network 224 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular communications network, or any other type of communication network configured such that data may be transferred between and among elements of the system 200.

The PTR 210, and the STRs 212a-b, as described throughout may generally be any type of television receiver, television converter, etc., such as a set-top boxy (STB) for example. In another example, the PTR 210, and the STRs 212a-b, may exhibit functionality integrated as part of or into a television, a DVR (Digital Video Recorder), a computer such as a tablet computing device, or any other computing system or device, as well as variations thereof. Further, the PTR 210 and the network 224, together with the STRs 212a-b and televisions 214a-c, and possibly the computing devices 216a-b, may each be incorporated within or form at least a portion of a particular home computing network. Further, the PTR 210 may be configured so as to enable communications in accordance with any particular communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection), etc. Other examples are possible. For example, one or more of the various elements or components of the example system 200 may be configured to communicate in accordance with the MoCA® (Multimedia over Coax Alliance) home entertainment networking standard. Still other examples are possible.

In practice, the satellites 206a-c may each be configured to receive uplink signals 226a-c from the satellite uplink 204. In this example, each the uplink signals 226a-c may contain one or more transponder streams of particular data or content, such as one or more particular television channels, as supplied by the service provider 202. For example, each of the respective uplink signals 226a-c may contain various media or media content such as encoded HD (High Definition) television channels, SD (Standard Definition) television channels, on-demand programming, programming information, and/or any other content in the form of at least one transponder stream, and in accordance with an allotted carrier frequency and bandwidth. In this example, different media content may be carried using different ones of the satellites 206a-c.

Further, different media content may be carried using different transponders of a particular satellite (e.g., satellite 206a); thus, such media content may be transmitted at different frequencies and/or different frequency ranges. For example, a first and second television channel may be carried on a first carrier frequency over a first transponder of satellite 206a, and a third, fourth, and fifth television channel may be carried on second carrier frequency over a first transponder of satellite 206b, or, the third, fourth, and fifth television channel may be carried on a second carrier frequency over a second transponder of satellite 206a, and etc. Each of these television channels may be scrambled such that unauthorized persons are prevented from accessing the television channels.

The satellites 206a-c may further be configured to relay the uplink signals 226a-c to the satellite dish 208 as downlink signals 228a-c. Similar to the uplink signals 226a-c, each of the downlink signals 228a-c may contain one or more transponder streams of particular data or content, such as various encoded and/or at least partially electronically scrambled television channels, on-demand programming, etc., in accordance with an allotted carrier frequency and bandwidth. The downlink signals 228a-c, however, may not necessarily contain the same or similar content as a corresponding one of the uplink signals 226a-c. For example, the uplink signal 226a may include a first transponder stream containing at least a first group or grouping of television channels, and the downlink signal 228a may include a second transponder stream containing at least a second, different group or grouping of television channels. In other examples, the first and second group of television channels may have one or more television channels in common. In sum, there may be varying degrees of correlation between the uplink signals 226a-c and the downlink signals 228a-c, both in terms of content and underlying characteristics.

Further, satellite television signals may be different from broadcast television or other types of signals. Satellite signals may include multiplexed, packetized, and modulated digital signals. Once multiplexed, packetized and modulated, one analog satellite transmission may carry digital data representing several television stations or service providers. Some examples of service providers include HBO®, CBS®, ESPN®, and etc. Further, the term “channel,” may in some contexts carry a different meaning from or than its normal, plain language meaning. For example, the term “channel” may denote a particular carrier frequency or sub-band which can be tuned to by a particular tuner of a television receiver. In other contexts though, the term “channel” may refer to a single program/content service such as HBO®.

Additionally, a single satellite may typically have multiple transponders (e.g., 32 transponders) each one broadcasting a channel or frequency band of about 24-27 MHz in a broader frequency or polarity band of about 500 MHz. Thus, a frequency band of about 500 MHz may contain numerous sub-bands or channels of about 24-27 MHz, and each channel in turn may carry a combined stream of digital data comprising a number of content services. For example, a particular hypothetical transponder may carry HBO®, CBS®, ESPN®, plus several other channels, while another particular hypothetical transponder may itself carry 3, 4, 5, 6, etc., different channels depending on the bandwidth of the particular transponder and the amount of that bandwidth occupied by any particular channel or service on that transponder stream. Further, in many instances a single satellite may broadcast two orthogonal polarity bands of about 500 MHz. For example, a first polarity band of about 500 MHz broadcast by a particular satellite may be left-hand circular polarized, and a second polarity band of about 500 MHz may be right-hand circular polarized. Other examples are possible.

Continuing with the example scenario, the satellite dish 208 may be provided for use to receive television channels (e.g., on a subscription basis) provided by the service provider 202, satellite uplink 204, and/or satellites 206a-c. For example, the satellite dish 208 may be configured to receive particular transponder streams, or downlink signals 228a-c, from one or more of the satellites 206a-c. Based on the characteristics of the PTR 210 and/or satellite dish 208, however, it may only be possible to capture transponder streams from a limited number of transponders concurrently. For example, a particular tuner of the PTR 210 may be configured to tune to a single transponder stream from a transponder of a single satellite at a time.

Additionally, the PTR 210, which is communicatively coupled to the satellite dish 208, may subsequently select via tuner, decode, and relay particular transponder streams to the television 214c for display thereon. For example, the satellite dish 208 and the PTR 210 may, respectively, be configured to receive, decode, and relay at least one premium HD-formatted television channel to the television 214c. Programming or content associated with the HD channel may generally be presented live, or from a recording as previously stored on, by, or at the PTR 210. Here, the HD channel may be output to the television 214c in accordance with the HDMI/HDCP content protection technologies. Other examples are however possible.

Further, the PTR 210 may select via tuner, decode, and relay particular transponder streams to one or both of the STRs 212a-b, which may in turn relay particular transponder streams to a corresponding one of the televisions 214a-b for display thereon. For example, the satellite dish 208 and the PTR 210 may, respectively, be configured to receive, decode, and relay at least one television channel to the television 214a by way of the STR 212a. Similar to the above-example, the television channel may generally be presented live, or from a recording as previously stored on the PTR 210, and may be output to the television 214a by way of the STR 212a in accordance with a particular content protection technology and/or networking standard. Still further, the satellite dish 208 and the PTR 210 may, respectively, be configured to receive, decode, and relay at least one premium television channel to one or each of the computing devices 216a-c. Similar to the above-examples, the television channel may generally be presented live, or from a recording as previously stored on the PTR 210, and may be output to one or both of the computing devices 216a-c in accordance with a particular content protection technology and/or networking standard.

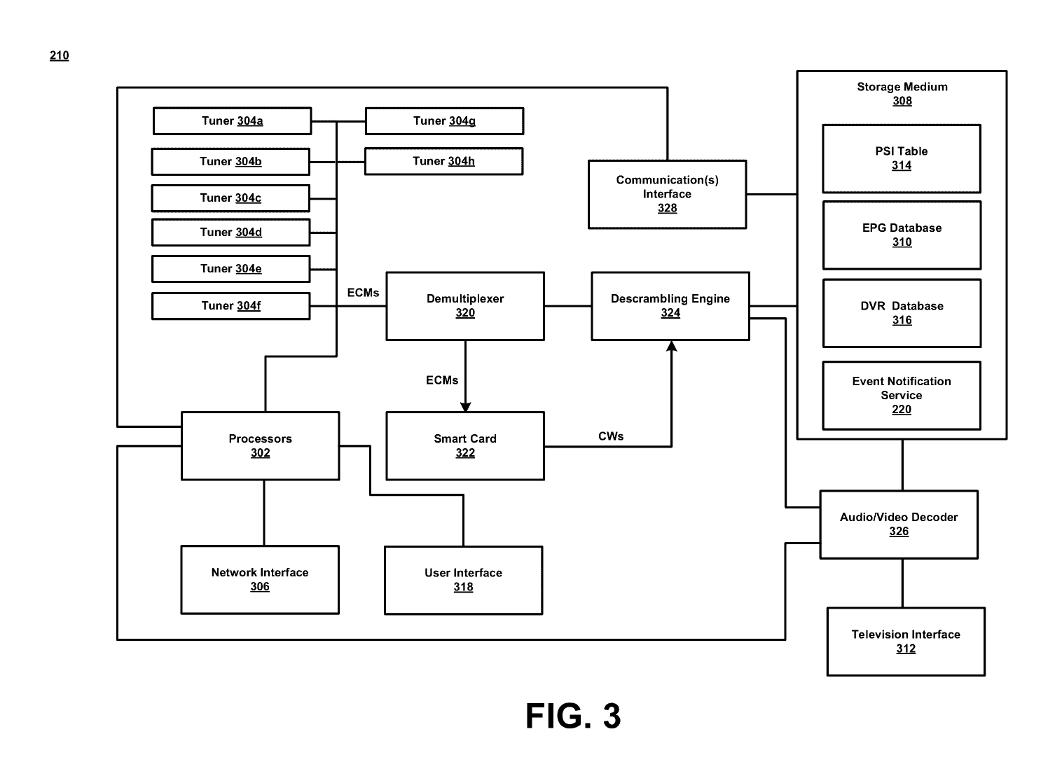

Referring now to FIG. 3, an example block diagram of the PTR 210 of FIG. 2 is shown in accordance with the disclosure. In some examples, the STRs 312a-b may be configured in a manner similar to that of the PTR 210. In some examples, the STRs 312a-b may be configured and arranged to exhibit a reduced functionality as compared to the PTR 210, and may depend at least to a certain degree on the PTR 210 to implement certain features or functionality. The STRs 312a-b in this example may be each referred to as a “thin client.”

The PTR 210 may include one or more processors 302, a plurality of tuners 304a-h, at least one network interface 306, at least one non-transitory computer-readable storage medium 308, at least one EPG database 310, at least one television interface 312, at least one PSI (Program Specific Information) table 314, at least one DVR database 316, at least one user interface 318, at least one demultiplexer 320, at least one smart card 322, at least one descrambling engine 324, at least one decoder 326, and at least one communication interface 328. In other examples, fewer or greater numbers of components may be present. Further, functionality of one or more components may be combined; for example, functions of the descrambling engine 324 may be performed by the processors 302. Still further, functionality of components may be distributed among additional components, and possibly additional systems such as, for example, in a cloud-computing implementation.

The processors 302 may include one or more specialized and/or general-purpose processors configured to perform processes such as tuning to a particular channel, accessing and displaying EPG information, and/or receiving and processing input from a user. For example, the processors 302 may include one or more processors dedicated to decoding video signals from a particular format, such as according to a particular MPEG (Motion Picture Experts Group) standard, for output and display on a television, and for performing or at least facilitating decryption or descrambling.

The tuners 304a-h may be used to tune to television channels, such as television channels transmitted via satellites 206a-c. Each one of the tuners 304a-h may be capable of receiving and processing a single stream of data from a satellite transponder, or a cable RF channel, at a given time. As such, a single tuner may tune to a single transponder or, for a cable network, a single cable channel. Additionally, one tuner (e.g., tuner 304a) may be used to tune to a television channel on a first transponder stream for display using a television, while another tuner (e.g., tuner 304b) may be used to tune to a television channel on a second transponder for recording and viewing at some other time. If multiple television channels transmitted on the same transponder stream are desired, a particular tuner (e.g., tuner 304c) may be used to receive the signal containing the multiple television channels for presentation and/or recording of each of the respective multiple television channels, such as in a PTAT (Primetime Anytime) implementation for example. Although eight tuners are shown, the PTR 210 may include more or fewer tuners (e.g., three tuners, sixteen tuners, etc.), and the features of the disclosure may be implemented similarly and scale according to the number of tuners of the PTR 210.

The network interface 306 may be used to communicate via alternate communication channel(s) with a service provider. For example, the primary communication channel between the service provider 202 of FIG. 2 and the PTR 210 may be via satellites 206a-c, which may be unidirectional to the PTR 210, and another communication channel between the service provider 202 and the PTR 210, which may be bidirectional, may be via the network 224. In general, various types of information may be transmitted and/or received via the network interface 306.

The storage medium 308 may represent a non-transitory computer-readable storage medium. The storage medium 308 may include memory and/or a hard drive. The storage medium 308 may be used to store information received from one or more satellites and/or information received via the network interface 306. For example, the storage medium 308 may store information related to the EPG database 310, the PSI table 314, and/or the DVR database 316, among other elements or features, such as the ENS module 220 mentioned above. Recorded television programs may be stored using the storage medium 308 and ultimately accessed therefrom.

The EPG database 310 may store information related to television channels and the timing of programs appearing on such television channels. Information from the EPG database 310 may be used to inform users of what television channels or programs are available, popular and/or provide recommendations. Information from the EPG database 310 may be used to generate a visual interface displayed by a television that allows a user to browse and select television channels and/or television programs for viewing and/or recording. Information used to populate the EPG database 310 may be received via the network interface 306 and/or via satellites 206a-c of FIG. 2. For example, updates to the EPG database 310 may be received periodically or at least intermittently via satellite. The EPG database 310 may serve as an interface for a user to control DVR functions of the PTR 210, and/or to enable viewing and/or recording of multiple television channels simultaneously.

The decoder 326 may convert encoded video and audio into a format suitable for output to a display device. For instance, the decoder 326 may receive MPEG video and audio from the storage medium 308 or the descrambling engine 324, to be output to a television. MPEG video and audio from the storage medium 308 may have been recorded to the DVR database 316 as part of a previously-recorded television program. The decoder 326 may convert the MPEG video and audio into a format appropriate to be displayed by a television or other form of display device and audio into a format appropriate to be output from speakers, respectively. The decoder 326 may be a single hardware element capable of decoding a finite number of television channels at a given time, such as in a time-division arrangement. In the example embodiment, eight television channels may be decoded concurrently or simultaneously.

The television interface 312 output a signal to a television, or another form of display device, in a proper format for display of video and play back of audio. As such, the television interface 312 may output one or more television channels, stored television programming from the storage medium 308, such as television programs from the DVR database 316 and/or information from the EPG database 310 for example, to a television for presentation.

The PSI table 314 may store information used by the PTR 210 to access various television channels. Information used to populate the PSI table 314 may be received via satellite, or cable, through the tuners 304a-h and/or may be received via the network interface 306 over the network 224 from the service provider 202 shown in FIG. 2. Information present in the PSI table 314 may be periodically or at least intermittently updated. Information that may be present in the PSI table 314 may include: television channel numbers, satellite identifiers, frequency identifiers, transponder identifiers, ECM PIDs (Entitlement Control Message, Packet Identifier), one or more audio PIDs, and video PIDs. A second audio PID of a channel may correspond to a second audio program, such as in another language. In some examples, the PSI table 314 may be divided into a number of tables, such as a NIT (Network Information Table), a PAT (Program Association Table), and a PMT (Program Management Table).

Table 1 below provides a simplified example of the PSI table 314 for several television channels. It should be understood that in other examples, many more television channels may be represented in the PSI table 314. The PSI table 314 may be periodically or at least intermittently. As such, television channels may be reassigned to different satellites and/or transponders, and the PTR 210 may be able to handle this reassignment as long as the PSI table 314 is updated.

TABLE 1

| Channel | Satellite | Transponder | ECM PID | Audio PIDs | Video PID |
|---|---|---|---|---|---|
| 4 | 1 | 2 | 27 | 2001 | 1011 |
| 5 | 2 | 11 | 29 | 2002 | 1012 |
| 7 | 2 | 3 | 31 | 2003 | 1013 |
| 13 | 2 | 4 | 33 | 2003, 2004 | 1013 |

It should be understood that the values provided in Table 1 are for example purposes only. Actual values, including how satellites and transponders are identified, may vary. Additional information may also be stored in the PSI table 314. Video and/or audio for different television channels on different transponders may have the same PIDs. Such television channels may be differentiated based on which satellite and/or transponder to which a tuner is tuned.

DVR functionality of the PTR 210 may permit a television channel to be recorded for a period of time. The DVR database 316 may store timers that are used by the processors 302 to determine when a television channel should be tuned to and recorded to the DVR database 316 of storage medium 308. In some examples, a limited amount of space of the storage medium 308 may be devoted to the DVR database 316. Timers may be set by the service provider 202 and/or one or more users of the PTR 210. DVR functionality of the PTR 210 may be configured by a user to record particular television programs. The PSI table 314 may be used by the PTR 210 to determine the satellite, transponder, ECM PID, audio PID, and video PID.

The user interface 318 may include a remote control, physically separate from PTR 210, and/or one or more buttons on the PTR 210 that allows a user to interact with the PTR 210. The user interface 318 may be used to select a television channel for viewing, view information from the EPG database 310, and/or program a timer stored to the DVR database 316 wherein the timer may be used to control the DVR functionality of the PTR 210.

Referring back to the tuners 304a-h, television channels received via satellite may contain at least some encrypted or scrambled data. Packets of audio and video may be scrambled to prevent unauthorized users, such as nonsubscribers, from receiving television programming without paying the service provider 202. When one of the tuners 304a-h is receiving data from a particular transponder of a satellite, the transponder stream may be a series of data packets corresponding to multiple television channels. Each data packet may contain a PID, which in combination with the PSI table 314, can be determined to be associated with a particular television channel. Particular data packets, referred to as ECMs may be periodically transmitted. ECMs may be encrypted; the PTR 210 may use the smart card 322 to decrypt ECMs.

The smart card 322 may function as the CA (Controlled Access) which performs decryption of encryption data to obtain control words that are used to descramble video and/or audio of television channels. Decryption of an ECM may only be possible when the user (e.g., an individual who is associated with the PTR 210) has authorization to access the particular television channel associated with the ECM. When an ECM is received by the demultiplexer 320 and the ECM is determined to correspond to a television channel being stored and/or displayed, the ECM may be provided to the smart card 322 for decryption.

When the smart card 322 receives an encrypted ECM from the demultiplexer 320, the smart card 322 may decrypt the ECM to obtain some number of control words. In some examples, from each ECM received by the smart card 322, two control words are obtained. In some examples, when the smart card 322 receives an ECM, it compares the ECM to the previously received ECM. If the two ECMs match, the second ECM is not decrypted because the same control words would be obtained. In other examples, each ECM received by the smart card 322 is decrypted; however, if a second ECM matches a first ECM, the outputted control words will match; thus, effectively, the second ECM does not affect the control words output by the smart card 322. When an ECM is received by the smart card 322, it may take a period of time for the ECM to be decrypted to obtain the control words. As such, a period of time, such as about 0.2-0.5 seconds, may elapse before the control words indicated by the ECM can be obtained. The smart card 322 may be permanently part of the PTR 210 or may be configured to be inserted and removed from the PTR 210.

The demultiplexer 320 may be configured to filter data packets based on PIDs. For example, if a transponder data stream includes multiple television channels, data packets corresponding to a television channel that are not desired to be stored or displayed by the user may be ignored by the demultiplexer 320. As such, only data packets corresponding to the one or more television channels desired to be stored and/or displayed may be passed to either the descrambling engine 324 or the smart card 322; other data packets may be ignored. For each channel, a stream of video packets, a stream of audio packets and/or a stream of ECM packets may be present, each stream identified by a PID. In some examples, a common ECM stream may be used for multiple television channels. Additional data packets corresponding to other information, such as updates to the PSI table 314, may be appropriately routed by the demultiplexer 320.

The descrambling engine 324 may use the control words output by the smart card 322 in order to descramble video and/or audio corresponding to television channels for storage and/or presentation. Video and/or audio data contained in the transponder data stream received by the tuners 304a-h may be scrambled. The video and/or audio may be descrambled by the descrambling engine 324 using a particular control word. The control word output by the smart card 322 to be used for successful descrambling may be indicated by a scramble control identifier present within the data packet containing the scrambled video or audio. Descrambled video and/or audio may be output by the descrambling engine 324 to the storage medium 308 for storage, such as part of the DVR database 316 for example, and/or to the decoder 326 for output to a television or other presentation equipment via the television interface 312.

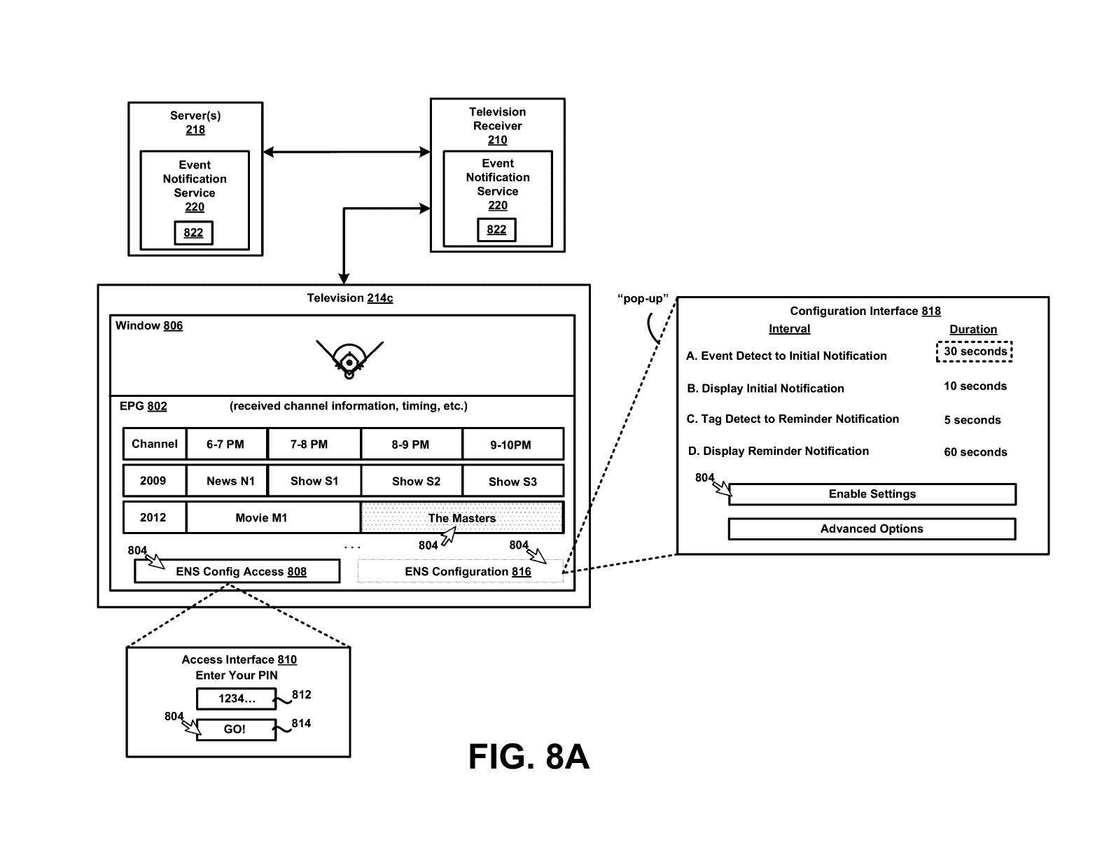

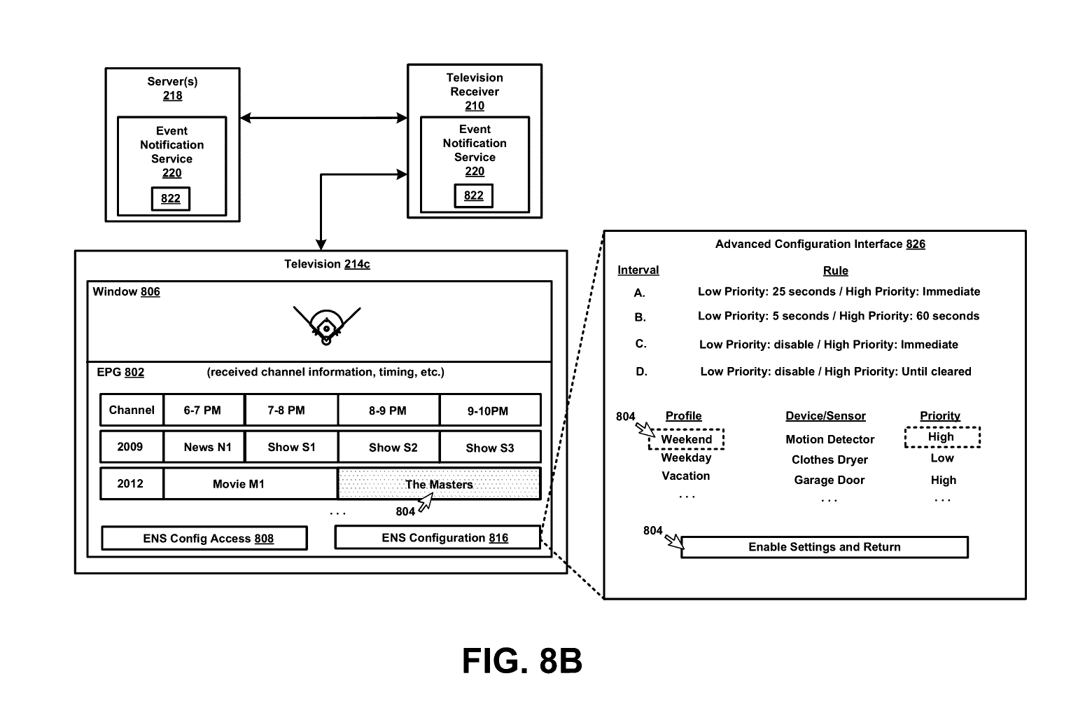

The communication interface 328 may be used by the PTR 210 to establish a communication link or connection between the PTR 210 and one or more of the computing systems and devices as shown in FIG. 2 and FIG. 4, discussed further below. It is contemplated that the communication interface 328 may take or exhibit any form as desired, and may be configured in a manner so as to be compatible with a like component or element incorporated within or to a particular one of the computing systems and devices as shown in FIG. 2 and FIG. 4, and further may be defined such that the communication link may be wired and/or or wireless. Example technologies consistent with the principles or aspects of the present disclosure may include, but are not limited to, Bluetooth®, WiFi, NFC (Near Field Communication), HomePlug®, and/or any other communication device or subsystem similar to that discussed below in connection with FIG. 8.

For brevity, the PTR 210 is depicted in a simplified form, and may generally include more or fewer elements or components as desired, including those configured and/or arranged for surfacing home automation-related event notifications to satellite television viewers or customers, in accordance with the principles of the present disclosure. For example, the PTR 210 is shown in FIG. 3 to include an instance of the ENS module 220 as mentioned above in connection with FIG. 2. While shown stored to the storage medium 308 as executable instructions, the ENS module 220 could, wholly or at least partially, be stored to the processor(s) 302 of the PTR 210. Further, some routing between the various modules of PTR 210 has been illustrated. Such illustrations are for exemplary purposes only. The state of two modules not being directly or indirectly connected does not indicate the modules cannot communicate. Rather, connections between modules of the PTR 210 are intended only to indicate possible common data routing. It should be understood that the modules of the PTR 210 may be combined into a fewer number of modules or divided into a greater number of modules.

Additionally, although not explicitly shown in FIG. 3, the PTR 210 may include one or more logical modules configured to implement a television steaming media functionality that encodes video into a particular format for transmission over the Internet such as to allow users to remotely view and control a home cable, satellite, or personal video recorder system from an Internet-enabled computer with a broadband Internet connection. The Slingbox® by Sling Media, Inc. of Foster City, Calif., is one example of a product that implements such functionality. Further, the PTR 210 may be configured to include any number of other various components or logical modules that are implemented in hardware, software, firmware, or any combination thereof, and such components or logical modules may or may not be implementation-specific.

Referring now to FIG. 4, an example HAS (Home Automation System) 400 is shown in accordance with the present disclosure. In an example, the HAS 400 may be hosted by the PTR 210 of FIG. 2, and thus the PTR 210 may be considered a home automation gateway device or system. An overlay device 428 is also shown in FIG. 4. In another example, the HAS 400 may be hosted by the overlay device 428 of FIG. 4, and thus the overlay device 428 may be considered a home automation gateway device or system. Still other examples are possible. For instance, in some example, features or functionality of the overlay device 428 may be wholly or at least partially incorporated into the PTR 210 (and vice versa), so that the HAS 400 may be considered to be hosted or managed or controlled by both PTR 210 and the overlay device 428. In this manner, the PTR 210, the overlay device 428, or any combination of functionality thereof, may be considered the central feature or aspect of the example HAS 400.

Accordingly, the PTR 210 and/or the overlay device 428 may be configured and/or arranged to communicate with multiple sensor devices, including at least the various in-home or on-residence home automation-related systems and/or devices shown in this example. Some examples of sensor devices may include, but are not limited to: at least one pet door/feeder 402, at least one smoke/CO₂ detector 404, a home security system 406, at least one security camera 408, at least one window sensor 410, at least one door sensor 412, at least one weather sensor 414, at least one shade controller 416, at least one utility monitor 418, at least one third party device 420, at least one health sensor 422, at least one communication device 424, at least one intercom 426, at least one overlay device 428, at least one display device 430, at least one cellular modem 432, at least one light controller 434, at least one thermostat 436, at least one leak detection sensor 438, at least one appliance controller 440, at least one garage door controller 442, at least one lock controller 444, at least one irrigation controller 446, and at least one doorbell sensor 448. The HAS 400 of FIG. 4 is just an example. Other examples are possible, as discussed further below.

It is contemplated that the each of the elements of FIG. 4, that which with the PTR 210 communicates, may use different communication standards. For example, one or more elements may use or otherwise leverage a ZigBee® communication protocol, while one or more other devices may communicate with the PTR 210 using a Z-Wave® communication protocol. As another example, one or more elements may use or otherwise leverage a WiFi communication protocol, while one or more other devices may communicate with the PTR 210 using a Bluetooth communication protocol. Any combination thereof is further contemplated, and other forms of wireless communication may be used by particular elements of FIG. 4 to enable communications to and from the PTR 210, such as any particular IEEE (Institute of Electrical and Electronics Engineers) standard or specification or protocol, such as the IEEE 802.11 technology for example.

In some examples, a separate device may be connected with the PTR 210 to enable communication with the smart home automation systems or devices of FIG. 4. For instance, the communication device 424 as shown coupled with the PTR 210 may take the form of a dongle. In some examples, the communication device 424 may be configured to allow for Zigbee®, Z-Wave®, and/or other forms of wireless communication. In some example, the communication device 424 may connect with the PTR 210 via a USB (Universal Serial Bus) port or via some other type of (e.g., wired) communication port. Accordingly, the communication device 424 may be powered by the PTR 210 or may be separately coupled with another different particular power source. In some examples, the PTR 210 may be enabled to communicate with a local wireless network and may use communication device in order to communicate with devices that use a ZigBee® communication protocol, Z-Wave® communication protocol, and/or some other wireless communication protocols.

In some examples, the communication device 424 may also serve to allow or enable additional components to be connected with the PTR 210. For instance, the communication device 424 may include additional audio/video inputs (e.g., HDMI), component, and/or composite inputs to allow for additional devices (e.g., Blu-Ray players) to be connected with the PTR 210. Such a connection may allow video comprising home automation information to be “overlaid” with television programming, both being output for display by a particular presentation device. Whether home automation information is overlaid onto video on display may be triggered based on a press of a remote control button by an end-user.

Regardless of whether the PTR 210 uses the communication device 242 to communicate with any particular home automation device shown in FIG. 4 or other particular home automation device not explicitly shown in FIG. 4, the PTR 210 may be configured to output home automation information for presentation via the display device 430. It is contemplated that the display device 430 could correspond to any particular one of the mobile devices 216a-b and televisions 214a-c as shown in FIG. 2. Still other examples are possible. Such information may be presented simultaneously, concurrently, in tandem, etc., with any particular television programming received by the PTR 210 via any particular communication channel as discussed above. It is further contemplated that the PTR 210 may also, at any particular instant or given time, output only television programming or only home automation information based on preferences or commands or selections of particular controls within an interface of or by any particular end-user. Furthermore, an end-user may be able to provide input to the PTR 210 to control the HAS 400, in its entirety as hosted by the PTR 210 or by the overlay device 428, as discussed further below.

In some examples (indicated by intermittent line in FIG. 4), the overlay device 428 may be coupled with the PTR 210 to allow or enable home automation information to be presented via the display device 430. It is contemplated that the overlay device 428 may be configured and/or arranged to overlay information, such as home automation information, onto a signal that will ultimately enable the home automation information to be visually presented via the display device 430. In this example, the PTR 210 may receive, decode, descramble, decrypt, store, and/or output television programming. The PTR 210 may output a signal, such as in the form of an HDMI signal. Rather than being directly input to the display device 430, however, the output of the PTR 210 may be input to the overlay device 428. Here, the overlay device 428 may receive video and/or audio output from the PTR 210.

The overlay device 428 may add additional information to the video and/or audio signal received from the PTR 210 so as to modify or augment or even “piggyback” on the same. That video and/or audio signal may then be output by the overlay device 428 to the display device 430 for presentation thereon. In some examples, the overlay device 428 may include or exhibit an HDMI input/output, with the HDMI output being connected to the display device 430. While FIG. 4 shows lines illustrating communication between the PTR 210 and other various devices, it will be appreciated that such communication may exist, in addition or in alternate via the communication device 424 and/or the overlay device 428. In other words, any particular input to the PTR 210 as shown in FIG. 4 may additionally, or alternatively, be supplied as input to one or both of the communication device 424 and the overlay device 428.

As alluded to above, the PTR 210 may be used to provide home automation functionality, but the overlay device 428 may be used to modify a particular signal so that particular home automation information may be presented via the display device 430. Further, the home automation functionality as detailed throughout in relation to the PTR 210 may alternatively be provided by or via the overlay device 428. Using the overlay device 428 to present automation information via the display device 430 may be beneficial and/or advantageous in many respects. For instance, it is contemplated that multiple devices may provide input video to the overlay device 428. For instance, the PTR 210 may provide television programming to the overlay device 428, a DVD/Blu-Ray player may provide video to the overlay device 428, and a separate IPTV device may stream other programming to the overlay device 428.

Regardless of the source of particular video/audio, the overlay device 428 may output video and/or audio that has been modified or augmented, etc., to include home automation information and then output to the display device 430. As such, regardless of the source of video/audio, the overlay device 428 may modify the audio/video to include home automation information and, possibly, solicit user input. For instance, in some examples the overlay device 428 may have four video inputs (e.g., four HDMI inputs) and a single video output (e.g., an HDMI output). In other examples, the PTR 210 may exhibit such features or functionality. As such, a separate device, such as a Blu-ray player may be connected with a video input of the PTR 210, thus allowing the PTR 210 to overlay home automation information when content from the Blu-Ray player is being output to the display device 430.

Regardless of whether the PTR 210 is itself configured to provide home automation functionality and output home automation input for display via the display device 430 or such home automation functionality is provided via the overlay device 428, home automation information may be presented by the display device 430 while television programming is also being presented by display device 430. For instance, home automation information may be overlaid or may replace a portion of television programming, such as broadcast content, stored content, on-demand content, etc., presented via the display device 430. FIG. 2 shows an example display (i.e., baseball game) by the television 214c, the same of which is supplied to the television 214c by the PTR 210 which may be configured to host the HAS 400 in accordance with the principles of the present disclosure. In FIG. 2, while television programming consisting of a baseball game is being presented, the display may be augmented with information related to home automation. In general, the television programming may represent broadcast programming, recorded content, on-demand content, or some other form of content.

An example of information related to home automation may include a security camera feed, as acquired by a camera at a front door of a residence. Such augmentation of the television programming may be performed directly by the PTR 210 (which may or may not be in communication with the communication device 424), the overlay device 428, or a combination thereof. Such augmentation may result in solid or opaque or partially transparent graphics being overlaid onto television programming (or other forms of video) output by the PTR 210 and displayed by the television 214c. Furthermore, the overlay device 428 and/or the PTR 210 may add or modify sound to television programming also or alternatively. For instance, in response to a doorbell ring, a sound may be played through the television 214c (or connected audio system). In addition or in alternate, a graphic may be displayed. In other examples, other particular camera data (e.g., nanny camera data) and/or associated sound or motion sensors may be integrated in the system and overlaid or otherwise made available to a user. For example, detection of a crying baby from a nanny camera may trigger an on-screen alert to a user watching television.

Returning to FIG. 4 alone, the PTR 210 and/or the overlay device 428, depending on implementation-specific details, may communicate with one or more wireless devices, such as the third party device 420. The third party device 420 may represent a tablet computer, cellular phone, laptop computer, remote computer, or some other device through which a user may desire to control home automation (device) settings and view home automation information in accordance with the principles of the present disclosure. Such a device also need not necessarily be wireless, such as in a traditional desktop computer embodiment. It is contemplated that the PTR 210, communication device 424, and/or the overlay device 428 may communicate directly with the third party device 420, or may use a local wireless network, such as network 224 for instance. The third party device 420 may be remotely located and not connected with a same local wireless network as one or more of the other devices or elements of FIG. 4.

Various home automation devices may be in communication with the ENS module 220 of the PTR 210 and/or the overlay device 428, depending on implementation-specific details. Such home automation devices may use similar or dissimilar communication protocols. Such home automation devices may communicate with the PTR 210 directly or via the communication device 424. Such home automation devices may be controlled by a user and/or have a status viewed by a user via the display device 430 and/or third party device 420. Such home automation devices may include, but are not limited to:

One or more cameras, such as the security camera 408. It is contemplated that the security camera 408 may be installed indoors, outdoors, and may provide a video and/or an audio stream that may be presented via the third party device 420 and/or display device 430. Video and/or audio from the security camera 408 may be recorded by the overlay device 428 and/or the PTR 210 continuously, in a loop as per a predefined time period, upon an event occurring, such as motion being detected by the security camera 408, and etc. For example, video and/or audio from security camera 408 may be continuously recorded such as in the form of a rolling window, thus allowing a period of time of video/audio to be reviewed by a user from before a triggering event and after the triggering event. Video/audio may be recorded on a persistent storage device local to overlay device 428 and/or the PTR 210, and/or may be recorded and stored on an external storage devices, such as a network attached storage device or the server 218 of FIG. 2. In some examples, video may be transmitted across a local and/or wide area network to other one or more other storage devices upon occurrence of a trigger event, for later playback. For initial setup for example, a still may be captured by the security camera 408 and stored by the PTR 210 for subsequent presentation as part of a user interface via the display device 430. In this way, an end-user can determine which camera, if multiple cameras are present or enabled, is being set up and/or later accessed. For example, a user interface may display a still image from a front door camera, which may be easily recognized by the user because it shows a scene near or adjacent a front door of a residence, to allow a user to select the front door camera for viewing as desired.

Furthermore, video and, possibly, audio from the security camera 408 may be available live for viewing by a user via the overlay device 428 or the PTR 210. Such video may be presented simultaneously with television programming being presented. In some examples, video may only be presented if motion is detected by the security camera 408, otherwise video from the security camera 408 may not be presented by a particular display device presenting television programming. Also, such video (and, possibly, audio) from the security camera 408 may be recorded by the PTR 210 and/or the overlay device 428. In some examples, such video may be recorded based upon a user-configurable timer. For instance, features or functionality associated with the security camera 408 may be incorporated into an EPG that is output by the PTR 210 for display by a presentation or display device.

For instance, data as captured by the security camera 408 may be presented or may otherwise be accessible as a “channel” as part of the EPG along with other typical or conventional television programming channels. Accordingly, a user may be permitted to select that channel associated with the security camera 408 to access data as captured by the security camera 408 for presentation via the display device 430 and/or the third party device 420, and etc. The user may also be permitted to set a timer to activate the security camera 408 to record video and/or audio for a user-defined period of time on a user-defined date. Such recording may not be constrained by the rolling window mentioned above associated with a triggering event being detected. Such an implementation may be beneficial, for example, if a babysitter is going to be watching a child and the parents want to later review the babysitter's behavior in their absence. In some examples, video and/audio acquired by the security camera 408 may be backed up to a remote storage device, such as cloud-based storage hosted by the server 218 of FIG. 2 for instance. Other data may also be cached to the cloud, such as configuration settings. Thus, if one or both of the PTR 210 and overlay device 428 malfunction, then a new device may be installed and the configuration data loaded onto the device from the cloud.

Further, one or more window sensors and door sensors, such as the window sensor 410 and the door sensor 412 may be integrated in to or as part of the HAS 400, and each may transmit data to the PTR 210, possibly via the communication device 424, or the overlay device 428, that indicates the status of a window or door, respectively. Such status may indicate open window or door, an ajar window or door, a closed window or door, and etc. When a status change occurs, an end-user may be notified as such via the third party device 420 and/or the display device 430, within an EPG or like interface for example. Further, a user may be able to view a status screen within an EPG or other interface to view the status one or more window sensors and/or one or more door sensors throughout the location. In some examples, the window sensor 410 and/or the door sensor 412 may have integrated “break” sensors to enable a determination as to whether glass or a hinge, or other integral component, etc., has been broken or compromised. Here, as well as in all instances of home automation related data as acquired and served to the PTR 210 and/or overlay device 428 by particular elements of FIG. 4, it is contemplated that one or both of the window sensor 410 and the door sensor 412 may be controlled via interaction with particular controls as provided within or by an EPG or like interface, and information or data as acquired by one or both of the window sensor 410 and door sensor 412 may be manipulated, consolidated, etc., as desired, and also made accessible within or by an EPG or like interface, such as a pop-up window, banner, and/or any other “interface” or “display” or the like, in accordance with the principles of the present disclosure.

Further, one or more smoke and/or CO detectors, such as detector 404, may be integrated in to or as part of the HAS 400. As such, alerts as to whether a fire (e.g., heat, smoke), CO, radon, etc., has been detected can be sent to the PTR 210, third party device 420, etc., and/or one or more emergency first responders. Accordingly, when an alert occurs, a user may be notified as such the via third party device 420 or the display device 430, within an EPG or like interface for example. Further, it is contemplated that such an interface may be utilized to disable false alarms, and that one or more sensors dispersed throughout a residence and/or integrated within the HAS 400 to detect gas leaks, radon, or various other dangerous situations. Here, as well as in all instances of home automation related data as acquired and served to the PTR 210 and/or overlay device 428 by particular elements of FIG. 4, the detector 404 may be controlled via interaction with particular controls as provided within or by an EPG or like interface, and information or data as acquired by the detector 404 may be manipulated, consolidated, etc., as desired, and also made accessible within or by an EPG or like interface in accordance with the principles of the present disclosure.

Further, a pet door and/or feeder, such as pet door and/or feeder 402 may be integrated in to or as part of the HAS 400. For instance, a predefined amount of food may be dispensed at predefined times to a pet. A pet door may be locked and/or unlocked. The pet's weight or presence may trigger the locking or unlocking of the pet door. For instance, a camera located at the pet door may be used to perform image recognition of the pet or a weight sensor near the door may identify the presence of the pet and unlock the door. A user may also lock/unlock a pet door and/or dispense food for example from a “remote” location. Here, as well as in all instances of home automation related data as acquired and served to the PTR 210 and/or overlay device 428 by particular elements of FIG. 4, the pet door and/or feeder 402 may be controlled via interaction with particular controls as provided within or by an EPG or like interface, and information or data as acquired by the pet door and/or feeder 402 may be consolidated, summarized, etc., and made accessible within or by an EPG or like interface in accordance with the principles of the present disclosure.

Further, a weather sensor, such as the weather sensor 414 may be integrated in to or as part of the HAS 400, and may allow or enable the PTR 210 and/or overlay device 428 to receive, identify, and/or output various forms of environmental data, including local or non-local ambient temperature, humidity, wind speed, barometric pressure, etc. Here, as well as in all instances of home automation related data as acquired and served to the PTR 210 and/or overlay device 428 by particular elements of FIG. 4, the weather sensor 414 may be controlled via interaction with particular controls as provided within or by an EPG or like interface, and information or data as acquired by the pet door and/or feeder 402 may be manipulated, consolidated, etc., as desired, and also made accessible within or by an EPG or like interface in accordance with the principles of the present disclosure.

Further, a shade controller, such as shade controller 416, may be integrated in to or as part of the HAS 400, and may allow for control of one or more shades, such as window, door, and/or skylight shades, within a home or residence or any other location. The shade controller 416 may respond to commands received from the PTR 210 and/or overlay device 428 and may provide status updates, such as “shade up” or “shade 50% up” or “shade down” and etc. Here, as well as in all instances of home automation related data as acquired and served to the PTR 210 and/or overlay device 428 by particular elements of FIG. 4, the shade controller 416 may be controlled via interaction with particular controls as provided within or by an EPG or like interface, and information or data as acquired by the shade controller 416 may be manipulated, consolidated, etc., as desired, and also made accessible within or by an EPG or like interface in accordance with the principles of the present disclosure.

Further, a utility monitor, such as utility monitor 418, may be integrated in to or as part of the HAS 400, and may serve to provide the PTR 210 and/or overlay device 428 with utility data or information, such as electricity usage, gas usage, water usage, wastewater usage, irrigation usage, etc. A user may via an EPG or like interface view a status page or may receive notifications upon predefined events occurring, such as electricity usage exceeding a defined threshold within a month, or current kilowatt usage exceeding a threshold. Here, as well as in all instances of home automation related data as acquired and served to the PTR 210 and/or overlay device 428 by particular elements of FIG. 4, the utility monitor 418 may be controlled via interaction with particular controls as provided within or by an EPG or like interface, and information or data as acquired by the utility monitor 418 may be manipulated, consolidated, etc., as desired, and also made accessible within or by an EPG or like interface in accordance with the principles of the present disclosure.

Further, a health sensor, such as health sensor 422, may be integrated in to or as part of the HAS 400, and may permit one or more vital characteristics of a particular individual to be acquired and/or monitored, such as a heart rate for instance. In some examples, additionally or alternatively, the health sensor 422 may contain a button or other type of actuator that a user can press to request assistance. As such, the health sensor 422 may be mounted to a fixed location, such as bedside, or may be carried by a user, such as on a lanyard. Such a request may trigger a notification to be presented to other users via the display device 430 and/or the third party device 420. Additionally or if the notification is not cleared by another user within a predefined period of time, a notification may be transmitted to emergency first responders to request help. In some examples, a home automation service provider may first try contacting the user, such as via phone, to determine if an emergency is indeed occurring. Such a health sensor 422 may have additional purposes, such as for notification of another form of emergency, such as a break-in, fire, flood, theft, disaster, etc.

In some examples, the health sensor 422 may be used as a medical alert pendant that can be worn or otherwise carried by an individual. It may contain a microphone and/or speaker to allow communication with other users and/or emergency first responders. The PTR 210 and/or overlay device 428 may be preprogrammed to contact a particular phone number, such as an emergency service provider, relative, caregiver, etc., based on an actuator of the health sensor 422 being activated by a user. The user may be placed in contact with a person via the phone number and the microphone and/or speaker of the health sensor 422. Furthermore, camera data may be combined with such alerts in order to give a contacted relative more information regarding the medical situation. For example, the health sensor 422, when activated in the family room, may generate a command which is linked with security camera footage from the same room. Furthermore, in some examples, the health sensor 422 may be able to monitor vitals of a user, such as a blood pressure, temperature, heart rate, blood sugar, etc. In some examples, an event, such as a fall or exiting a structure can be detected.

Further, in response to an alert from the health sensor 422 or some other emergency or noteworthy event, parallel notifications may be sent to multiple users at approximately the same time. As such, multiple people can be made aware of the event at approximately the same time (as opposed to serial notification). Therefore, whoever the event is most pertinent to or notices the notification first can respond. Which users are notified for which type of event may be customized by a user of the PTR 210. In addition to such parallel notifications being based on data from the health sensor 422, data from other devices may trigger such parallel notifications. For instance, a mailbox open, a garage door open, an entry/exit door open during wrong time, an unauthorized control of specific lights during vacation period, a water sensor detecting a leak or flow, a temperature of room or equipment is outside of defined range, and/or motion detected at front door are examples of possible events which may trigger parallel notifications.

Additionally, a configuring user may be able to select from a list of users to notify and method of notification to enable such parallel notifications. The configuring user may prioritize which systems and people are notified, and specify that the notification may continue through the list unless acknowledged either electronically or by human interaction. For example, the user could specify that they want to be notified of any light switch operation in their home during their vacation. Notification priority could be: 1) SMS Message; 2) push notification; 3) electronic voice recorder places call to primary number; and 4) electronic voice recorder places call to spouse's number. Other examples are possible, however, it is contemplated that the second notification may never happen if the user replies to the SMS message with an acknowledgment. Or, the second notification would automatically happen if the SMS gateway cannot be contacted. Here, as well as in all instances of home automation related data as acquired and served to the PTR 210 and/or overlay device 428 by particular elements of FIG. 4, the health sensor 422 may be controlled via interaction with particular controls as provided within or by an EPG or like interface, and information or data as acquired by the health sensor 422 may be manipulated, consolidated, etc., as desired, and also made accessible within or by an EPG or like interface in accordance with the principles of the present disclosure.

Further, an intercom, such as the intercom 426, may be integrated in to or as part of the HAS 400, and may permit a user in one location to communicate with a user in another location, who may be using the third party device 420, the display device 430, or some other device, such another television receiver within the structure. The intercom 426 may be integrated with the security camera 408 or may use a dedicated microphone/speaker, such as a Bluetooth® microphone. Microphones/speakers of the third party device 420, display device 430, communication device 242, overlay device 428, etc., may also or alternatively be used. A MOCA network or other appropriate type of network may be used to provide audio and/or video from the intercom 426 to the PTR 210 and/or to other television receivers and/or wireless devices in communication with the PTR 210. Here, as well as in all instances of home automation related data as acquired and served to the PTR 210 and/or overlay device 428 by particular elements of FIG. 4, the intercom 426 may be controlled via interaction with particular controls as provided within or by an EPG or like interface, and information or data as acquired by the intercom 426 may be manipulated, consolidated, etc., as desired, and also made accessible within or by an EPG or like interface in accordance with the principles of the present disclosure.

Further, a light controller, such as light controller 434, may be integrated in to or as part of the HAS 400, and may permit a light to be turned on, off, and/or dimmed by the PTR 210 or the overlay device 428, such as based on a user command received from the third party device 420 or directly via PTR 210 or overlay device 428, etc. The light controller 434 may control a single light. As such, multiple different ones of the light controller 434 may be present within a house or residence. In some examples, a physical light switch, that opens and closes a circuit of the light, may be left in the “on” position such that light controller 434 can be used to control whether the light is on or off. The light controller 434 may be integrated into a light bulb or a circuit, such as between the light fixture and the power source, to control whether the light is on or off. An end-user, via the PTR 210 or overlay device 428, may be permitted to view a status of each instance of the light controller 434 within a location.

Since the PTR 210 or overlay device 428 may communicate using different home automation protocols, different instances of the light controller 434 within a location may use disparate or different communication protocols, but may all still be controlled by the PTR 210 or overlay device 428. In some examples, wireless light switches may be used that communicate with the PTR 210 or overlay device 428. Such switches may use a different communication protocol than any particular instance of the light controller 434. Such a difference may not affect functionality because the PTR 210 or overlay device 428 can serve as a hub for multiple disparate communication protocols and perform any necessary translation and/or bridging functions. For example, a tablet computer may transmit a command over a WiFi connection and the PTR 210 or overlay device 428 may translate the command into an appropriate Zigbee® or Zwave® command for a wireless light bulb. In some examples, the translation may occur for a group of disparate or different devices. For example, a user may decide to turn off all lights in a room and select a lighting command on a tablet computer, the overlay device 428 may then identify the lights in the room and output appropriate commands to all devices over different protocols, such as a Zigbee® wireless light bulb and a Zwave® table lamp.

Additionally, it is contemplated that the PTR 210 may permit timers and/or dimmer settings to be set for lights via the light controller 434. For instance, lights can be configured to turn on/off at various times during a day according to a schedule and/or events being detected by the HAS 400, etc. Here, as well as in all instances of home automation related data as acquired and served to the PTR 210 and/or overlay device 428 by particular elements of FIG. 4, each particular instance of the light controller 434 may be controlled via interaction with particular controls as provided within or by an EPG or like interface, and information or data as acquired by each particular instance of the light controller 434 may be manipulated, consolidated, etc., as desired, and also made accessible within or by an EPG or like interface in accordance with the principles of the present disclosure.

Further, a thermostat, such as the thermostat 436, may be integrated in to or as part of the HAS 400, and may provide heating/cooling updates to the PTR 210 and/or overlay device 428 for display via display device 430 and/or third party device 420. Further, control of thermostat 436 may be effectuated via the PTR 210 or overlay device 428, and zone control within a structure using multiple thermostats may also be possible. Here, as well as in all instances of home automation related data as acquired and served to the PTR 210 and/or overlay device 428 by particular elements of FIG. 4, the thermostat 436 may be controlled via interaction with particular controls as provided within or by an EPG or like interface, and information or data as acquired by the thermostat 436 may be manipulated, consolidated, etc., as desired, and also made accessible within or by an EPG or like interface in accordance with the principles of the present disclosure.

Further, a leak detection sensor, such as the leak detection sensor 438, may be integrated in to or as part of the HAS 400, and may be used to determine when a water leak as occurred, such as in pipes supplying water-based fixtures with water. The leak detection sensor 438 may be configured to attach to the exterior of a pipe and listen for a sound of water moving within a pipe. In other examples, sonar, temperature sensors or ion infused water with appropriate sensors may be used to detect moving water. As such, cutting or otherwise modifying plumbing may not be necessary to use or leverage the leak detection sensor 438. If water movement is detected for greater than a threshold period of time, it may be determined a leak is occurring. The leak detection sensor 438 may have a component that couples over an existing valve such that the flow of water within one or more pipes can be stopped.

For instance, if the leak detection sensor 438 determines a leak may be occurring, a notification may be provided to a user via the third party device 420 and/or display device 430 by the PTR 210 and/or overlay device 428. If a user does not clear the notification, the flow of water may be shut off by the leak detection sensor 438 after a predefined period of time. A user may also be able to provide input to allow the flow of water to continue or to immediately interrupt the flow of water. Here, as well as in all instances of home automation related data as acquired and served to the PTR 210 and/or overlay device 428 by particular elements of FIG. 4, the leak detection sensor 438 may be controlled via interaction with particular controls as provided within or by an EPG or like interface, and information or data as acquired by the leak detection sensor 438 may be manipulated, consolidated, etc., as desired, and also made accessible within or by an EPG or like interface in accordance with the principles of the present disclosure.

Further, an applicant controller, such as the appliance controller 440, may be integrated in to or as part of the HAS 400, and may permit a status of an appliance to be retrieved and commands to control operation to be sent to an appliance by the PTR 210 or overlay device 428. For instance, the appliance controller 440 may control a washing machine, a dryer, a dishwasher, an oven, a microwave, a refrigerator, a toaster, a coffee maker, a hot tub, or any other form of appliance. The appliance controller 440 may be connected with a particular appliance or may be integrated as part of the appliance. Additionally, or alternatively, the appliance controller 440 may enable for acquisition of data or information regarding electricity usage of one or more devices (e.g., other home automation devices or circuits within a home that are monitored) to be determined. Here, as well as in all instances of home automation related data as acquired and served to the PTR 210 and/or overlay device 428 by particular elements of FIG. 4, the appliance controller 440 may be controlled via interaction with particular controls as provided within or by an EPG or like interface, and information or data as acquired by the appliance controller 440 may be manipulated, consolidated, etc., as desired, and also made accessible within or by an EPG or like interface in accordance with the principles of the present disclosure.

Further, a garage door controller, such as the garage door controller 442, may be integrated in to or as part of the HAS 400, and may permit a status of a garage door to be checked and the door to be opened or closed by a user via the PTR 210 or overlay device 428. In some examples, based on a physical location of the third party device 420, the garage door may be controlled. For instance, if the third party device 420 is a cellular phone and it is detected to have moved a threshold distance away from a house having the garage door controller 442 installed, a notification may be sent to the third party device 420. If no response is received within a threshold period of time, the garage may be automatically shut. If the third party device 420 moves within a threshold distance of the garage door controller 442, the garage may be opened. Here, as well as in all instances of home automation related data as acquired and served to the PTR 210 and/or overlay device 428 by particular elements of FIG. 4, the garage door controller 442 may be controlled via interaction with particular controls as provided within or by an EPG or like interface, and information or data as acquired by the garage door controller 442 may be manipulated, consolidated, etc., as desired, and also made accessible within or by an EPG or like interface in accordance with the principles of the present disclosure.

Further, a lock controller, such as the lock controller 444, may be integrated in to or as part of the HAS 400, and may permit a door to be locked and unlocked and/or monitored by a user via the PTR 210 or overlay device 428. In some examples, the lock controller 444 may have an integrated door sensor 412 to determine if the door is open, shut, or partially ajar. Being able to only determine if a door is locked or unlocked may not be overly useful—for instance, a lock may be in a locked position, but if the door is ajar, the lock may not prevent access to the house. Therefore, for security, a user may benefit from knowing both that a door is closed or open and locked or unlocked. To accomplish such notification and control, the lock controller 444 may have an integrated door sensor 412 that allows for the lock controller 444 to lock/unlock a door and provide a status as to whether the door is open or shut. Therefore, a single device may control a lock and determine whether the associated door is shut or open. No mechanical or electrical component may need to be integrated separately into a door or doorframe to provide such functionality. Such a single device may have a single power source that allows for sensing of the lock position, sensing of the door position, and for engagement/disengagement of the lock.

For example, the lock controller 444 may have an integrated door sensor that includes a reed switch or proximity sensor that detects when the door is in a closed position, with a plate of the lock in proximity to a plate on the door frame of the door. For instance, a plate of the lock may have an integrated magnet or magnetized doorframe plate. When in proximity to the magnet, a reed switch located in the lock controller 444 may be used to determine that the door is closed; when not in proximity to the magnet, the reed switch located in the lock controller 444 may be used to determine that the door is at least partially ajar. Rather than using a reed switch, other forms of sensing may also be used, such as a proximity sensor to detect a doorframe. In some examples, the sensor to determine the door is shut may be integrated directly into the deadbolt or other latching mechanism of the lock controller 444. When the deadbolt is extended, a sensor may be able to determine if the distal end of the deadbolt is properly latched within a door frame based on a proximity sensor or other sensing means. Here, as well as in all instances of home automation related data as acquired and served to the PTR 210 and/or overlay device 428 by particular elements of FIG. 4, the lock controller 444 may be controlled via interaction with particular controls as provided within or by an EPG or like interface, and information or data as acquired by the lock controller 444 may be manipulated, consolidated, etc., as desired, and also made accessible within or by an EPG or like interface in accordance with the principles of the present disclosure.

Further, a home security system, such as the home security system 406, may be integrated in to or as part of the HAS 400. In general, the home security system 406 may detect motion, when a user has armed/disarmed the home security system 406, when windows/doors are opened or broken, etc. The PTR 210 may adjust settings of the home automation devices of FIG. 4 based on home security system 406 being armed or disarmed. For example, a virtual control and alarm panel may be presented to a user via the display device 430. The functions of a wall mounted panel alarm can be integrated in the graphical user interface of the TV viewing experience such as a menu system with an underlying tree hierarchical structure. It is contemplated that the virtual control and alarm panel can appear in a full screen or PiP (Picture-in-Picture) with TV content. Alarms and event notification can be in the form of scrolling text overlays, popups, flashing icons, etc.

Additionally, camera video and/or audio, such as from the security camera 408, can be integrated with DVR content provided by the PTR 210 with additional search, zoom, time-line capabilities. The camera's video stream can be displayed full screen, PiP with TV content, or as a tiled mosaic to display multiple camera's streams at a same time. In some examples, the display can switch between camera streams at fixed intervals. The PTR 210 may perform video scaling, adjust frame rate and transcoding on video received from the security camera 408. In addition, the PTR 210 may adaptively transcode the camera content to match an Internet connection. Here, as well as in all instances of home automation related data as acquired and served to the PTR 210 and/or overlay device 428 by particular elements of FIG. 4, the home security system 406 may be controlled via interaction with particular controls as provided within or by an EPG or like interface, and information or data as acquired by the home security system 406 may be manipulated, consolidated, etc., as desired, and also made accessible within or by an EPG or like interface in accordance with the principles of the present disclosure.

Further, an irrigation controller, such as the irrigation controller 446, may be integrated in to or as part of the HAS 400, and may allow for a status and control of an irrigation system, such as a sprinkler system, to be controlled by a user via the PTR 210 and/or overlay device 428. The irrigation controller 446 may be used in conjunction with the weather sensor 414 to determine whether and/or for how long (duration) the irrigation controller 446 should be activated for watering. Further, a user, via the PTR 210 and/or overlay device 428, may turn on, turn off, or adjust settings of the irrigation controller 446. Here, as well as in all instances of home automation related data as acquired and served to the PTR 210 and/or overlay device 428 by particular elements of FIG. 4, the irrigation controller 446 may be controlled via interaction with particular controls as provided within or by an EPG or like interface, and information or data as acquired by the irrigation controller 446 may be manipulated, consolidated, etc., as desired, and also made accessible within or by an EPG or like interface in accordance with the principles of the present disclosure.

Further, a doorbell sensor, such as the doorbell sensor 448, may be integrated in to or as part of the HAS 400, and may permit an indication of when a doorbell has been rung to be sent to multiple devices, such as the PTR 210 and/or the third party device 420. In some examples, the doorbell sensor 448 detecting a doorbell ring may trigger video to be recorded by the security camera 408 of the area near the doorbell and the video to be stored until deleted by a user, or stored for predefined period of time. Here, as well as in all instances of home automation related data as acquired and served to the PTR 210 and/or overlay device 428 by particular elements of FIG. 4, the doorbell sensor 448 may be controlled via interaction with particular controls as provided within or by an EPG or like interface, and information or data as acquired by the doorbell sensor 448 may be manipulated, consolidated, etc., as desired, and also made accessible within or by an EPG or like interface in accordance with the principles of the present disclosure.

For example, “selection” of a doorbell by an individual so as to “trigger” the doorbell sensor 448 may activate or engage the PTR 210 to generate and output for display by a presentation device, such as the television 214c, a user interface, display, pop-up, etc., that which may include particular information such as “There is someone at your front door ringing the doorbell” for example. Additional, or alternative, actions such as activating, by the PTR 210, a security camera to record video and/or audio of the individual at the front door are contemplated as well. Further, similar steps or actions may be taken or implemented by the PTR 210 for example in response to a signal generated in response to detection of an event, etc., received by the PTR 210 from any of the elements of FIG. 4.

Additional forms of sensors not illustrated in FIG. 4 may also be incorporated as part of the HAS 400. For instance, a mailbox sensor may be attached to a mailbox to determine when mail is present and/or has been picked up. The ability to control one or more showers, baths, and/or faucets from the PTR 210 and/or the third party device 420 may also be possible. Pool and/or hot tub monitors may be incorporated into the HAS 400. Such sensors may detect whether or not a pump is running, water temperature, pH level, a splash/whether something has fallen in, etc. Further, various characteristics of the pool and/or hot tub may be controlled via the home automation system. In some examples, a vehicle “dashcam” may upload or otherwise make video/audio available to the PTR 210 when within range of a particular residence. For instance, when a vehicle has been parked within range of a local wireless network with which the PTR 210 is connected, video and/or audio may be transmitted from the dashcam to the PTR 210 for storage and/or uploading to a remote server, such as the server 218 as shown in FIG. 2. Here, as well as in all instances of home automation related data as acquired and served to the PTR 210 and/or overlay device 428 by particular elements of FIG. 3, such systems or sensors or devices may be controlled via interaction with particular controls as provided within or by an EPG or like interface, and information or data as acquired by such systems or sensors or devices may be manipulated, consolidated, etc., as desired, and also made accessible within or by an EPG or like interface in accordance with the principles of the present disclosure.

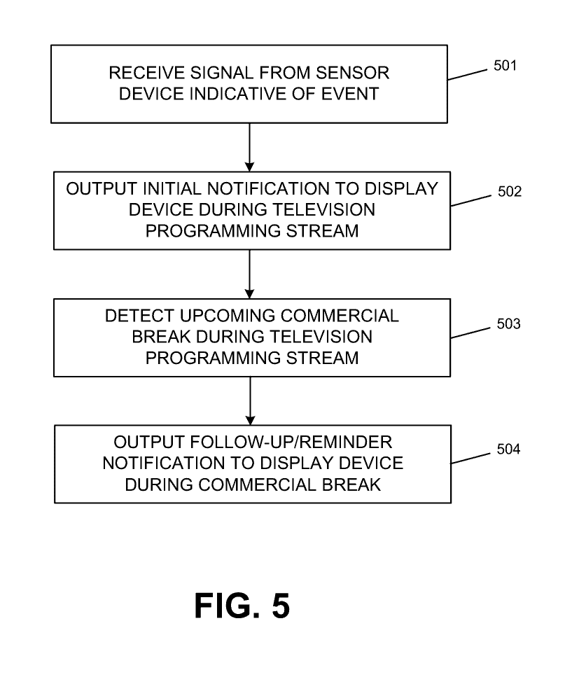

Referring now to FIG. 5, a flow diagram is shown illustrating a first example process of determining and outputting initial and follow-up notifications on a display device in response to an event detected within a home automation system. As described below, the steps in this process may be performed by one or more components in the notification systems 110 and corresponding computing environments described above, such as event notification services 220 executing within servers 218 and/or television receivers 210 within satellite television distribution networks 200. However, it should be understood that the processes of receiving events via sensor devices in a home automation system, generating initial and delayed notifications, and other features described herein need not be limited to the specific systems and hardware implementations described above in FIGS. 1-4, but may be performed within other computing environments comprising other combinations of hardware and software components. For example, this example process may be implemented not only within satellite television distribution systems, but also within terrestrial television distribution systems, telecommunications systems, Internet-based content distribution networks, cellular and other mobile networking systems, and the like.

In step 501, a notification system 110 may receive a signal indicative of an event detected by any particular one of a plurality of sensor devices of a home automation system. As discussed above, in various embodiments, an event notification system 110 may be implemented as a standalone device within home automation system. Additionally or alternatively, notification system 110 may be integrated within one or more other devices or systems at the server-side or within local user equipment, for example, as an event notification service 220 executing within a satellite television receiver incorporated into a home automation system. For example, a television receiver 210 may receive a signal from a security camera system 408 in response to detection, by the security camera system, of movement or motion at or near a back door of a residence. As another example, the television receiver 210 may receive a signal from a smart device or sensor 440 coupled to a clothes dryer in response to detection, by the smart home automation device, of completion of a particular drying cycle. Many other examples are possible.

In step 502, the notification system 110 may output to a display device 430 (e.g., television) for display thereby a first or initial notification that is descriptive of the event detected by the particular one of a plurality of smart devices or sensors of the home automation system in step 501. For example, assume that a viewer is watching a television program, and that during the broadcast of the television program the security camera system 408 detects movement or motion at or near the back door of the residence. In this example, the notification system 110 may, substantially immediately following the detection, output to the television for display a notification (e.g., “Security Camera; Motion Near Back Door Detected”) while the viewer is watching the television program. Such an initial notification may be displayed for any configurable amount of time (e.g., thirty (30) seconds). As another example, if the viewer is watching the television program, and that program the smart device or sensor 440 coupled to the clothes dryer detects completion of a particular drying cycle. In this example, the notification system 110 may, substantially immediately following the detection, output to the television for display a notification (e.g., “Clothes Dryer; Full Cycle Complete”) while the viewer is watching the television program. In this example, the notification also may be displayed for any configurable amount of time (e.g., amount ten (10) seconds) and may be different from the amount of time that other notifications having different priority levels are displayed. Although only two examples are described in this section of events detected via sensor devices and corresponding notifications output, it should be understood that many other examples are possible using any of the sensor devices, display devices, and/or system configuration options described herein.

In the examples above, the viewer might not necessarily be concerned enough about the motion detected at the back door, and/or the completion of the drying cycle, to take a break from the television network show in order to investigate. Accordingly, the viewer may dismiss the initial notification, either expressly by selected a dismiss option (e.g., a “Dismiss” or “Snooze” or “Remind me Later” button in a user interface), or implicitly by taking no action. The viewer may dismiss the initial notification confidently based on the knowledge that the notification system 110 is configured and/or arranged to output a follow-up reminder notification at what might be considered a less invasive or a more preferred time during the broadcast of the television program. For instance, the notification system 110 may be configured and/or arranged to detect an upcoming commercial break within the television program, and then during a time period corresponding to the commercial break output a reminder notification (e.g., “Reminder: Security Camera; Motion Near Back Door Recently Detected” or “Reminder: Clothes Dryer; Full Cycle Complete”).

In step 503, and continuing with the above-example, the notification system 110 (e.g., terrestrial or satellite television receiver) may detect an upcoming commercial break in or during the television program. For example, the television receiver may “read” in substantially real-time one or more metadata tags embedded within the television transmission signals corresponding to the television program, to detect an upcoming commercial break in or during the television program. For example, a particular tag embedded within the television signal transmitted from a satellite or cable headend read at a time t₁ by the television receiver may indicate that the start of an upcoming commercial break in or during the television program may occur at t₁+five (5) seconds. In this example, the notification system 110 (e.g., the television receiver itself 210) may then generate an interrupt to command the television receiver at step 504 to output to the television a second notification, which may be displayed as a follow-up or reminder notification, at or about time=t₁+five (5) seconds. Like the initial notification output in step 502, the follow-up or reminder notification output in step 504 may describe the event detected by the sensor device(s) of the home automation system in step 501. In this example, the notification system 110 may output for display a reminder notification at what might be considered a less invasive or a more preferred time during the broadcast of the network programs, for instance, during a commercial break. As discussed below, in other embodiments, initial and/or delayed notifications may be output during other more preferred times (e.g., changes in television channel, data source, switching devices, etc.). Advantageously, such implementations may serve to entice new customers to subscribe to home automation services as offered by a television provider or other content provider, together or in tandem with typical television programming related services, as well as provide an incentive for existing customers to maintain their loyalty and/or relationship with the television provider.

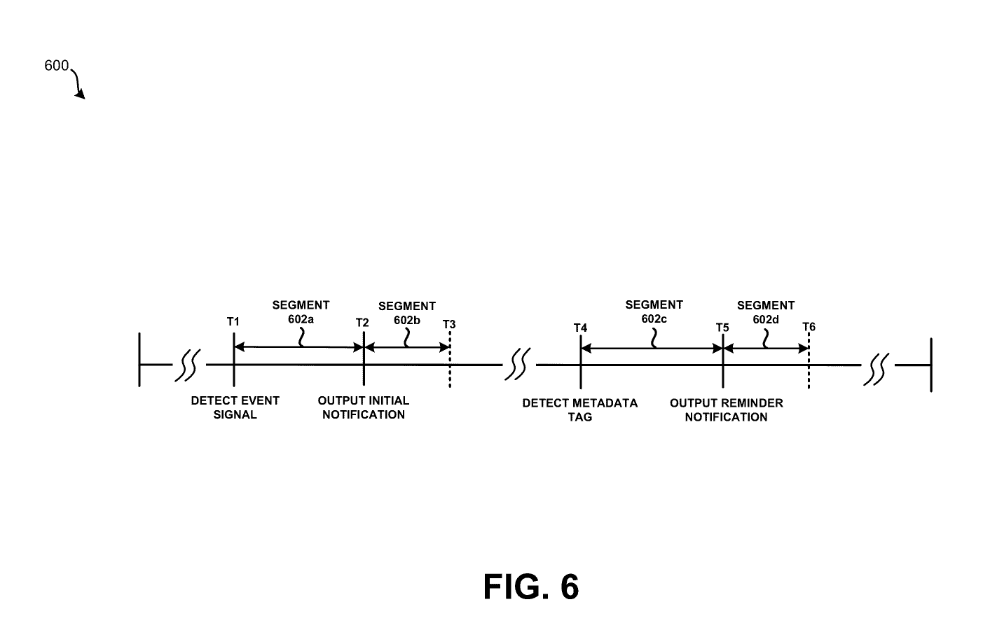

Referring now to FIG. 6, an example timeline 600 is shown for surfacing home automation-related event notifications to users via display devices, in accordance with the present disclosure. In this example, and with reference to FIG. 2 and FIG. 4, the notification system 110 (e.g., one or more event notification service modules 220) may at time T1 receive a signal from a one or more sensor devices of a home automation system 400 that is indicative of a detected event. For example, a notification system 110 (e.g., implemented as a ENS module 220 within a television receiver 210) may receive a signal from the home security system 406 (see FIG. 4) in response to detection of, by the security camera 408, movement or motion at or near a back door of a residence or other monitored location. Next, the ENS module 220 may at time T2 until time T3 output to one or more of display devices (e.g., televisions 214a-c and/or other display devices 430) for display thereby a first or initial notification 604 (see FIG. 2) that is descriptive of the event. For example, the ENS module 220 may output to a television 214c for display thereby a notification “Security Camera; Motion Near Back Door Detected” while a viewer is watching a television program. It is contemplated that the length or duration of each one of time segment 602a and time segment 602b may be programmable, as discussed in further detail below in connection with FIGS. 8A and 8B.

Next, and continuing with the example, the ENS module 220 may at time T4 detect an upcoming commercial break in or during the television program. For example, one or more tags may be embedded within a satellite signal or transponder stream carrying the television program, which may be read by the ENS module 220 at time T4, may indicate that the start of an upcoming commercial break in or during the television program may occur at time T4+five (5) seconds. Next, the ENS module 220 may at time T5 until time T6 output to one or more of the televisions 214a-c for display thereby a second or reminder notification 606 (see FIG. 2) that is descriptive of the event. For example, the ENS module 220 may output to the television 214c (but shown on television 214a for example purposes only) for display thereby a notification “Reminder: Security Camera; Motion Near Back Door Recently Detected” while a viewer is watching the network television show. In some embodiments, one or more characteristics of the delayed (e.g., follow-up or reminder) notification 606 may be different than the characteristics of the initial notification 604. For example, the delayed notification 606 may be “enlarged” and/or be animated and/or include different font, font size, coloring, etc., as compared to the initial notification 604. Additionally, the length or duration of each one of time segment 602c and time segment 602d may be programmable/configurable in some embodiments, as discussed in further detail below in connection with FIGS. 8A and 8B.

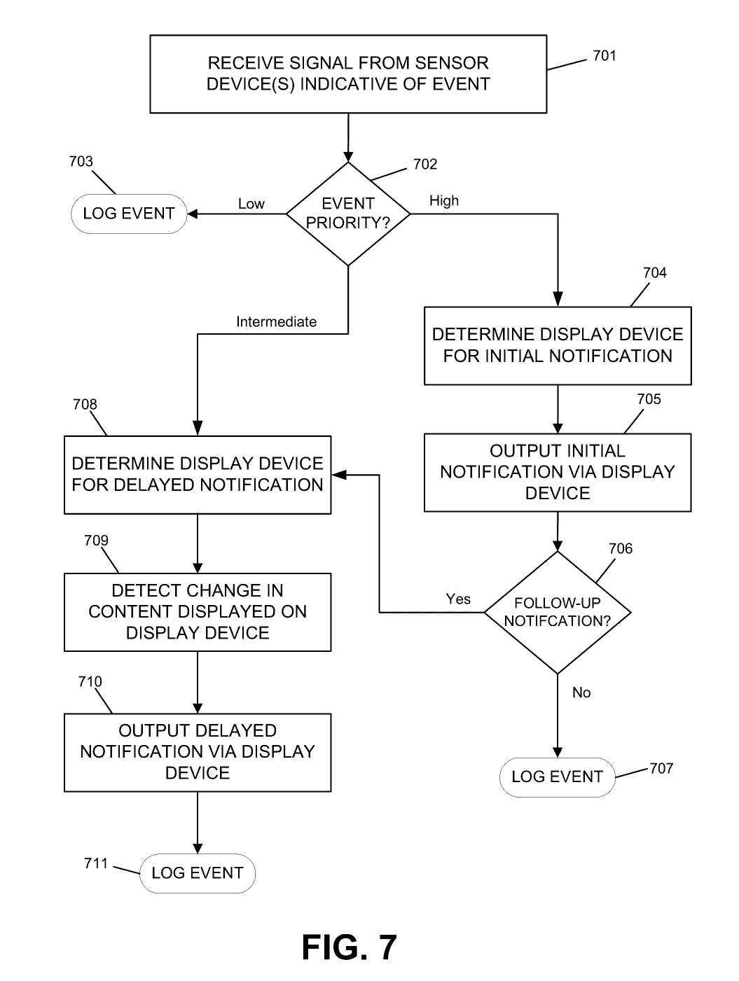

Referring now to FIG. 7, a flow diagram is shown illustrating an example process of receiving and analyze sensor data, and then generating initial and/or delayed notifications via one or more display devices. As discussed above with FIG. 5, the steps in FIG. 7 may be performed by one or more components in the notification systems 110 and corresponding computing environments described above, such as event notification services 220 executing within servers 218 and/or television receivers 210 within satellite television distribution networks 200. However, it should be understood that the processes of receiving and analyzing sensor data from sensor devices, as well as generating and surfacing initial and/or delayed notifications to various display devices need not be limited to the specific systems and hardware implementations described above in FIGS. 1-4, but may be performed within other computing environments comprising other combinations of hardware and software components. For example, this example process may be implemented not only within satellite television distribution systems, but also within terrestrial television distribution systems, telecommunications systems, Internet-based content distribution networks, cellular and other mobile networking systems, and the like.

The example process shown in FIG. 7 may be similar in some respects to the example of FIG. 5, in that both may display initial event notifications and delayed (e.g., follow-up or reminder) event notifications in response to detecting a change in the content displayed on the display device (e.g., a commercial break during a television programming stream). However, in contrast to FIG. 5, which provided a relatively simple example of receiving sensor data from a sensor device 140, outputting an immediate initial notification via a display device 130 (e.g., a television), and then outputting a follow-up/reminder notification during a television commercial break, FIG. 7 may correspond to a more complex and variable process example in several respects. For example, as described below, the process shown in FIG. 7 may include additional aspects such as evaluating event priority, and may generate different numbers of event notifications (e.g., 0, 1, or 2) based on event priority and other factors. FIG. 7 also incorporates further aspects of display device selection for initial notifications and/or delayed notifications, as well as incorporating the user responses received to initial notifications when determining if and when (and how many) delayed notifications should be surfaced. Moreover, as described below in reference to FIGS. 8A and 8B, the example process of FIG. 7 allows for several additional user configuration options, such as defining user-specific and/or device-specific event notifications, defining priority levels for different types of event notifications, defining delayed notification preferences, defining notification lengths, delay lengths, etc.

In step 701, a notification system 110 may receive a signal including sensor data corresponding to an event detected by one or more sensor devices 140. As discussed above, sensor devices 140 may include various sensors, appliances, and/or electronic devices within a home automation system 400 or other computing environment. In some cases, notification system 110 may be implemented as a standalone device within such a home automation system 400. In other cases, notification system 110 may be implemented as an event notification service 220 integrated within a television receiver 210 or other network-enabled user equipment, such as a wireless router, gaming console, smartphone, home computer, or the like. Some or all of the notification system 110 also may be implemented within a server 218 or other computing systems/devices remote from the sensor devices 140, such as satellite hub device, cable headend, Internet server, or the like.

As discussed in reference to step 501, the sensor data received in step 701 may correspond to any sensor data detected or determined by any type of sensor device 140 operating within the system. For example, the sensor data received in step 701 may include alert signals from security cameras or motion sensors in a home security system 406, status signals from home appliances or office equipment 140, data readings from utility monitor devices 140, etc.

In different cases, the determination an “event” has occurred (i.e., the determination that the sensor data received from sensor devices 140 should be logged or should result in an event notification output to a display device 130) may be performed by the notification system 110 or sensor devices 140 themselves, or a combination of the sensor devices 140 and the notification system 110. For example, a security system sensor device 140 (e.g., 406) may be configured to detect and analyze visual data, audio data, and the like, determine that an home security event has occurred, and transmit data indicative the event to the notification system 110. Other sensor devices 140 such as home appliances, office equipment, utilities monitors, weather sensors, and the like, also may be configured to detect device-specific events and transmit data indicative of the event to the notification system 110. However, in other examples, sensor devices 140 may detect and transmit sensor data to a notification system 110, which then analyzes the received data and determines whether or not the sensor data corresponds to an event. For instance, a weather sensor device 140 (e.g., 414) or utility monitor sensor device 140 (e.g., 418) may detect and transmit sensor readings to the notification system 110, which compares the readings to event thresholds stored within the notification system 110 to determine events such as excess power usage events, device malfunction events, extreme weather events, etc.

Regardless of whether an event is determined by a notification system 110, a sensor device 140, or a combination of one or more of these systems and devices, many events determinations may include comparing sensor data detected or determined by a sensor device 140 to previously stored data thresholds. In some embodiments, such data thresholds for triggering events may be user configurable, and users may define and update such thresholds using configuration user interfaces such as those shown in FIGS. 8A and 8B. Additionally, in some cases, the determination that an event has occurred (i.e., that the data should be logged and/or output via an event notification) may be based on data from multiple sensor devices 140. For example, based on a first set of sensor data from a first sensor device 140 (e.g., high temperature readings from a weather sensor 414) and a second set of sensor data from a second sensor device 140 (e.g., malfunction of air conditioning unit from an appliance controller 440), the notification system 110 may determine that an event should be triggered (e.g., logging and/or notifications output to display devices 130), whereas the event might not be triggered in response to either the first set or second set of sensor data individually. In some cases, notification systems 110 and/or sensor devices 140 also may determine that an event has occurred based on the captured sensor data as well as based on the times and/or days that the sensor data was captured. For example, sensor data indicating that a pet door has been used (e.g., from sensor device 402) may trigger an event when occurring at certain times (e.g., late night, early mornings, etc.), but not at other times (e.g., late mornings, afternoons, etc.). Additionally, the activation of a garage door controller sensor 442 may trigger an event when a homeowner has set the home security system 406 setting to a “Vacation” setting, but might not trigger an event the home security system 406 is set to “Away” or “At Home,” and so on.

In step 702, the notification system 110 may determine a priority level associated with the sensor data/event indicator received in step 701. In this example, all events may be classified into one of three priority levels: Low, Intermediate, and High. For instance, as discussed above in other examples, a low priority event (702: Low) may correspond to an indication from a washer/dryer or other appliance controller 440 that a cycle or task has been completed. In this example, the notification system 110 may log low priority events in step 703 (e.g., within an event log in data stores 115), but does not generate or output notifications to display devices 130 in response to low priority events. An intermediate priority event (702: Intermediate), for example, may correspond to a severe weather warning from a weather sensor 414, or a malfunction detection from a household appliance controller 440, or the like. As described below in steps 708-711, the notification system 110 in this example does not output immediate notifications in response to intermediate priority events, but instead generates and outputs delayed notifications for intermediate events. A high priority event (702: High) may be, for example, a power surge or short circuit detected by a power sensor device 418, a water leak detected by device 438, a positive detection of a motion sensor and/or security camera of a home security system 406, etc. As described below in steps 704-711, the notification system 110 in this example may output an immediate notification and potentially one or more delayed notifications (e.g., follow-up or reminder notifications) in response to high priority events. Although three event priority level are used in this example, it should be understood that any number of different priority levels (e.g., 1, 2, 4, . . . , 10, etc.) may be used in different examples. Additionally, in various embodiments, the notification system 110 may support user configuration and customization priority levels. For example, the notification system 110 may provide user interfaces such as those discussed below in reference to FIGS. 8A and 8B, to allow users to configure the number of different priority levels available, as well as the corresponding actions to be taken in response to each different priority level.

In steps 704-705, in response to the determination that a high-priority event has occurred, the notification system 110 may generate and surface (e.g., output to one or more display devices 130) an initial event notification. In some embodiments, initial notifications may be output immediately by the notification system 110 (e.g., in real-time or near real-time) in response to the determination of the event in step 701 (and/or determination of priority level in step 702).

In step 704, the notification system 110 may determine a display device 130 on which to output the initial notification. In some cases, the notification system 110 may select a display device from a plurality of display devices (e.g., 130a-130d) within a home automation system 400, or from a plurality of display devices associated with one or more specific users. For example, a notification system 110 implemented within a television receiver 220 of a home automation system 400 may be configured to select from one or more display devices 130 associated with the home automation system 400, including televisions, personal computers, tablet computers, user smartphones, vehicle-based display systems, etc. The selection in step 704 of a specific display device 130 (or multiple display devices) on which to output the initial notification may be based on the current operational status of the plurality of devices 130, as well as based on system configuration settings and user preferences stored in data store 115. In some cases, the notification system 110 may determine which of the associated display devices 130 is currently turned-on and/or actively displaying content to users. For example, if a first home television is turned-on and displaying a television program, movie, video game content, etc., then the notification system 110 may select that television in step 704. Alternatively, if the television is currently turned off, but an associated computing device (e.g., a home computer, tablet computer, user smartphone, etc.) is currently being used for media content display, web browsing, gaming, or the like, then the notification system 110 may select that computing device to receive the initial notification in step 704. In some embodiments, the notification system 110 may be configured to select devices 130 for surfacing notifications that are currently displaying content using certain software applications (e.g., web browsers, multimedia players, gaming programs, etc.), but not other software applications (e.g., work-related programs, time-critical programs, etc.). In still other cases, initial notifications may be routed to an associated vehicle-based display device 130 when the notification system 110 detects that the vehicle is in use, or to a smartwatch or other wearable display device 130 when the notification system 110 detects that the wearable display device 130 is being used, and so on. Although a single display device 130 may be selected in this example, it should be understood that multiple display devices 130 may be selected to receive initial notifications and/or delayed notifications in various different examples.

Additionally, as noted above, the determination of one or more display devices in step 704 may be based on configuration settings and/or user preferences in some embodiments. For instance, if multiple display devices 130 within a home automation system or other computing environment 100 are currently turned-on and actively displaying content, then the notification system 110 may be pre-configured to select one of these devices 130 as a preferred display device for receiving notifications. Additionally or alternatively, the notification system 110 may provide user interfaces such as those discussed below in reference to FIGS. 8A and 8B, (and/or various programmatic software interfaces) to allow users to define preferred and not-preferred displayed devices 130, designate orders of display devices 130 on which to receive event notifications, and/or define complex rules for determining which display devices 130 will receive event notifications. Examples of complex rules that may be defined via user interfaces and/or preconfigured into the software of the notification system 110 for determining display devices in step 704 may include time-based rules (e.g., during specific days and/or time ranges, output event notifications via display device 130a), user-based rules (e.g., when an event notification is registered for and/or generated for User A, output the notification to display device 130b), sensor device-based rules (e.g., when an event notification is determined based on sensor data from a specific sensor device, output the notification to display device 130c), as well as complex rules based on combinations of multiple different such rule criteria.

In step 705, the notification system 110 may output an initial notification to the display device(s) 130 determined in step 704. In some cases, step 705 may be similar or identical to step 502 discussed above. For example, the notification system 110 may output an initial notification to a television, computer, smartphone, or other display device 130, using an overlay device 428 to obscure the displayed content, or may output an SMS message, push notification, audio notification, or the like. It should be understood that certain notification techniques may be available for some types of display devices 130 but not others. For example, an overlay device 428 may be used to generate and display graphical content comprising a notification to a television 430, while a similar notification may be sent to a user's smartphone via an email or SMS message. The content of the event notification may include, for example, the sensor device(s) 140 that caused the generation of the notification, the sensor readings or operational status of the sensor devices 140, an explanation of the notification, a recommendation of actions to perform (e.g., visual checks to confirm notification data, instructions for running device diagnostics or repairs, performing home security measures or notifying emergency personnel, etc.).

The event notifications output on display devices 130 also may include user interface components configured to receive a user response via the display device 130 or another related device (e.g., a television remote control device, gaming system controller, etc.). For example, the initial notification output in step 705 may include a user interface component that allows selection of one or more options for responding to the notification. Examples of user responses may include logging the notification to an event log, dismissing the notification, dismissing all such future notifications, or requesting additional information about the notification (e.g., a video feed of a security camera, specific sensor device readings, statistics reading previous device usage or utilities usage, etc.). Additionally, in some cases, users may expressly or implicitly request delayed notifications in response to initial notifications. For instance, an initial notification may be output to a display device in step 705 that allows a user to request a delayed notification (e.g., a follow-up or reminder notification) at a later time (e.g., in 5 minutes, 10 minutes, 1 hour, 1 day, etc.), or during the next break/change in content (e.g., a commercial break, channel change, etc.). Requests for delayed notifications also may include requests by the user that the delayed notification should be sent to a different display device 130.

In step 706, if the user has expressly requested a follow-up notification via a user interface screen of the initial notification (706: Yes), or if the notification system 110 determines that the user has implicitly requested a follow-up notification (e.g., by not responding to the initial notification within a predetermined time threshold) (706: Yes), then a delayed notification also may be output in response to this event, as described below in steps 708-711. Alternatively, if the user expressly declines a follow-up notification (e.g., by dismissing the initial notification) (706: No), then the notification system 110 in this example may log the event data and the user's response to the initial notification in step 707.

In steps 708-711, the notification system 110 may generate and surface (e.g., output to one or more display devices 130) a delayed event notification. Generally, delayed notifications may be determined, generated, and output in a similar or the same manner as initial notifications, described above. For example, the audio and/or visual content of delayed notifications may be similar to that of initial notifications, and the techniques used to generate and format the notification content for the selected display devices 130 and output the notifications onto the devices may be similar or the same to those described above. However, in contrast to initial notifications that may be output immediately by the notification system 110, delayed notifications may be output after a time delay from the determination of the event in step 701 (and/or determination of priority level in step 702). Such delays may be simple time-based delays (e.g., after 5 minutes, 10 minutes, 1 hour, 1 day, etc.), or event-based delays which may be configured to surface the delay notification at a more convenient time to the user.

In the example shown in FIG. 7, delayed notifications may be generated in two different cases. First, in the case of an intermediate priority event (702: Intermediate), a delayed notification may be generated and surfaced instead of an initial notification. For instance, the notification system 110 may determine that intermediate priority events are not urgent enough to immediately interrupt the content currently displaying on the display device 130, but that the user should be notified at a more convenient time in the future. Second, in the case of a high priority event (701: Intermediate), a delayed notification may be generated and surfaced after an initial notification, when the notification system 110 and/or the user response to the initial notification indicate that a follow-up notification should also be provided (706: Yes). For instance, a user may expressly request a follow-up notification in response to an initial notification on a display device 130 (e.g., by selecting a ‘Snooze’ option, ‘Remind me later’ option, ‘Remind me at commercial’ option, ‘Remind me after this program’ option, or the like).

In step 708, the notification system 110 may determine a display device 130 on which to output the delayed notification. In some embodiments, step 708 may be similar or identical to step 704, discussed above. For example, in step 708, the notifications system 110 may identify one or more of the display devices 130 that are turned-on and actively displaying content. Additionally, various different algorithms and techniques for selecting display devices 130 in step 708 may be preconfigured by the notification system 110 and/or customized by the user, as described above in step 704.

In some examples, the display device(s) 130 selected for a delayed notification in step 708 may be different than the display device(s) 130 that were selected for an initial notification in step 704 (or that would have been selected if an initial notification were surfaced). For instance, at the time when the notification system 110 determines that a delayed notification should be output, different ones of the display devices 130 may be turned-on and/or actively displaying content then the devices 130 that were turned-on and/or actively displaying content immediately after the event determination in step 701. Additionally, in some embodiments, different algorithms and/or user-defined rules may be setup for initial notifications and delayed notifications. For example, a user may define a first device-selection rule to be applied for selecting display devices 130 for surfacing initial notifications, and a second device-selection rule to be applied for selecting display devices 130 for surfacing delayed notifications. Thus, in the example shown in FIG. 7, a first display device 130a may be used to output an initial notification in step 705, while a second different display device 130b may be used to output a delayed notification in step 710.

In step 709, the notification system 110 may perform an ongoing monitoring process for each of the display device(s) selected in step 708, in order to detect a change in the content being displayed on the devices 130. In some examples, step 709 may be similar or identical to step 503 discussed above. For instance, when a display device 130 selected in step 708 is a television that is displaying a television programming stream received via television signal transmitted by a headend device (e.g., cable television headend server, a satellite television hub, Internet-based television server, etc.), then step 709 may include detecting an indicator embedded in the television signal identifying one or more television advertisements contained within the television programming stream. In such cases, the notification system 110, which may be implemented within a terrestrial or satellite television receiver, may upcoming commercial break within the current television program, for example, by reading one or more metadata tags embedded within the television transmission signals.

The above example, like the example in step 503, relates to detecting upcoming television advertisements (e.g., commercial breaks) within a television programming stream being displayed on a television 430 or other display device 130. However, in other examples, different types of changes in content displays may be detected, and the changes detected also may be on different types of display devices 130. For instance, the content being displayed on various display devices 130 may include live television programming, prerecorded television programs (e.g., television programs stored on digital video recorders or other local storage devices), streaming content from an Internet streaming content provider, interactive video games played via a gaming console, user web browsing behavior, etc. Accordingly, the changes in displayed content detected in step 709 may depend on the type of content being displayed (e.g., live or prerecord television programs, movies, music, audio, interactive gaming, web browsing, etc.), as well as the type of display device 130 (e.g., television, computer, tablet, smartphone, vehicle-based display, etc.). For instance, additional examples of detecting a change in displayed content in step 709 may include determining that a current television program, movie, or interactive video game has ended, that a user has changed the channel and/or changed the active data source (e.g., between live television, prerecorded television, an audio system, Internet content, a local digital video disc (DVD) player, gaming system, etc.), that a web-browsing session on a display device 130 has ended, or that a user has navigated to a different page or site while web browsing. In still other examples, the change detected in step 709 may correspond to the user turning off a display device 130, in which case one or more alternative or back-up display devices 130 may be selected. As yet another example, when the display device 130 is a vehicle-based display, then the detected change in step 709 may be a determination that the vehicle has stopped and/or reached its destination (e.g., the vehicle was put into park or neutral). It should be understood that the above examples are illustrative only and non-limiting, and that various other examples of detecting changes in displayed content may be performed in different embodiments, depending on the display devices 130 and type of content being displayed.

In step 710, the notification system 110 may output a delayed notification to the display device(s) determined in step 708, in response to the changes in the content displayed on those devices 130 detected in step 709. In some cases, step 710 may be similar or identical to step 705 discussed above. For example, the notification system 110 may output a delayed notification to a television, computer, smartphone, or other display device 130, using an overlay device 428 to obscure a portion of the displayed content, or may output an SMS message, email, push notification, audio notification, or the like. The content of delay notifications output in step 710 may or may not be identical to the content of an earlier initial notification output in step 705, in the cases when such initial notifications are output, but may generally contain similar content. For instance, a delayed notification may identify the sensor device(s) 140 that caused the generation of the notification, the sensor readings or operational status of the sensor devices 140, an explanation of the notification, a recommendation of actions to perform, etc. In this example, after outputting the delayed notification in step 710, the notification system 110 may log the event data and the user's response to the delayed and/or initial notifications in step 711.

Referring now to FIGS. 8A and 8B, two example screens are shown of a graphical interface allowing users to configure the notification system behaviors. As shown in these examples, a notification system 110 may be implemented by executing one or more instances of an event notification service 220 within a back-end server 218 and/or within a local device such as television receiver 210. In this example, the instances of the event notification service 220 may collaborate to perform the various functionality of the notification systems 110 described herein, as well as providing various user interfaces to allow users to configure and customize the behavior of the notification system 110. One or more configuration files 822 may be stored within the instances of the event notification service 220, which may correspond to data store 115, so the configuration data associated with specific notification systems 110, home automation systems 400, and/or users may be saved and downloaded to other devices (e.g., notification systems 110 at secondary residences, businesses, etc.).

FIGS. 8A and 8B show an example user interface window 806 displayed on a television device 214c. In these examples, window 806 includes an electronic programming guide (EPG) 802 and a selectable ENS configuration access button 808, which may be selected using a cursor 804 or other user interface selection technique. Upon selection of the ENS configuration access button 808, a separate access interface window 810 may be rendered, prompting the user to input an access code via textbox 812 and then select button 814. If the user's access code is valid, the user will be authenticated as an authorized user permitted to update the event notification configuration settings for the system. When the user authenticates successfully via access interface window 810, an ENS configuration button 816 may become visible and/or selectable, thereby allowing the user to invoke one or more configuration interface windows 818, which may be displayed as “pop-up” windows or submenus within the EPG 802.

In this example, configuration window 818 in FIG. 8A displays a set of notification display time rules for different intervals. Thus, configuration window 818 may relate to embodiments such as those discussed below in reference to FIGS. 5-6, in which an initial notification is displayed starting at a configurable time after event detection (Interval A, see segment 602a) and then displays for a configurable length of time (Interval B, see segment 602b), and a separate delayed notification is displayed starting at a configurable time after the detection of a metadata tag or other change in content (Interval C, see segment 602c) and then displays for another configurable length of time (Interval D, see segment 602d). Each of these time periods/segments may be configurable as shown in FIG. 8A. Additionally, as shown in FIG. 8B, the priority level for different types of events may be configurable using the advanced configuration interface window 826. In this simple example, users may specify a time profile (e.g., weekend, weekday, or vacation), and a sensor device (e.g., motion detector, clothes dryer, or garage door), and then set a corresponding priority level (e.g., high or low) for the defined event.

Additionally, although FIGS. 8A and 8B illustrate simple examples of notification configuration functionality, using an ENS 220 executing within a television receiver 210, and using a television 214c to provide configuration interfaces, it should be understand that other types of notification configurations may be performed on different implementations of notification systems 110 and different embodiments of configuration interfaces. For example, in other embodiments, configuration interfaces 818 and 826 may be displayed on other types of interactive display devices 130, such as home computers, tablet computers, smartphones, wearable devices, and vehicle-based computing devices. Additionally, various programmatic interfaces such as software tools and services, application programming interfaces, and the like may be supported instead of or in addition to graphical interfaces.

Moreover, many different types of event notification configurations may be performed using such interfaces, in addition to the examples shown in FIGS. 8A and 8B. For instance, as discussed above, priority levels for event notifications may be configured or customized based on which sensor devices detected the event, the time and date of the event detection, the user(s) to which the events notification is output, and/or the state of other devices in the home automation event (e.g., security system activation states), etc. Configuration interfaces also may be used to define user-specific and/or device-specific event notifications, define the number of different priority levels the corresponding actions to be taken in response to events of each different priority level, as well as the different behaviors and notification preferences for initial versus delayed notifications, etc. Additionally, threshold levels of sensor data/sensor readings for triggering events may be user configurable in some cases, and users may define and update such thresholds via configuration interfaces. Users also may define multi-device events in some cases (e.g., event based on data received from multiple sensor devices 140) using similar configuration interfaces. In still other examples, configuration interfaces may allow users to define preferred and not-preferred displayed devices 130, designate orders of display devices 130 on which to receive event notifications, and/or define complex rules for determining which display devices 130 will receive event notifications.

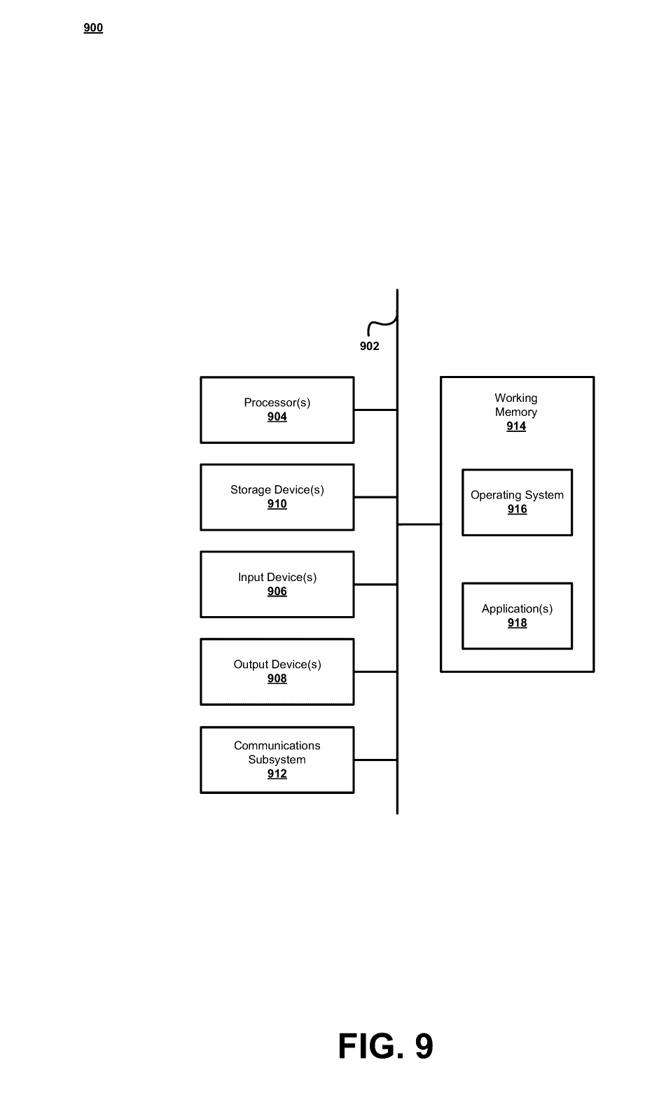

Referring now to FIG. 9, an example is shown of a computer system or device 900 in accordance with the disclosure. An example of a computer system or device includes a particular “smart” home automation-related sensor or device or system or controller or monitor or detector or the like, an enterprise server, blade server, desktop computer, laptop computer, tablet computer, personal data assistant, smartphone, gaming console, STB, television receiver, and/or any other type of machine configured for performing calculations. Any particular one of the previously-described computing devices may be wholly or at least partially configured to exhibit features similar to the computer system 900, such as any of the respective elements or components of at least FIGS. 1-4. In this manner, any of one or more of the respective elements of those figures may be configured and/or arranged, wholly or at least partially, for determining, generating, and surfacing event notifications via display devices 130 based on data received from sensor devices 140. Still further, any of one or more of the respective elements of at least FIG. 1-4 may be configured and/or arranged to include computer-readable instructions that, when executed, instantiate and implement functionality of a notification system 110 (e.g., one or more ENS modules 220).

The computer device 900 is shown comprising hardware elements that may be electrically coupled via a bus 902 (or may otherwise be in communication, as appropriate). The hardware elements may include a processing unit with one or more processors 904, including without limitation one or more general-purpose processors and/or one or more special-purpose processors (such as digital signal processing chips, graphics acceleration processors, and/or the like); one or more input devices 906, which may include without limitation a remote control, a mouse, a keyboard, and/or the like; and one or more output devices 908, which may include without limitation a presentation device (e.g., television), a printer, and/or the like.

The computer system 900 may further include (and/or be in communication with) one or more non-transitory storage devices 910, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 900 might also include a communications subsystem 912, which may include without limitation a modem, a network card (wireless and/or wired), an infrared communication device, a wireless communication device and/or a chipset such as a Bluetooth™ device, 802.11 device, WiFi device, WiMax device, cellular communication facilities such as GSM (Global System for Mobile Communications), W-CDMA (Wideband Code Division Multiple Access), LTE (Long Term Evolution), etc., and/or the like. The communications subsystem 912 may permit data to be exchanged with a network (such as the network described below, to name one example), other computer systems, and/or any other devices described herein. In many examples, the computer system 900 will further comprise a working memory 914, which may include a random access memory and/or a read-only memory device, as described above.

The computer device 900 also may comprise software elements, shown as being currently located within the working memory 914, including an operating system 916, device drivers, executable libraries, and/or other code, such as one or more application programs 918, which may comprise computer programs provided by various examples, and/or may be designed to implement methods, and/or configure systems, provided by other examples, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 910 described above. In some cases, the storage medium might be incorporated within a computer system, such as computer system 900. In other examples, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 900 and/or might take the form of source and/or installable code, which, upon compilation and/or installation on the computer system 900 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some examples may employ a computer system (such as the computer device 900) to perform methods in accordance with various examples of the disclosure. According to a set of examples, some or all of the procedures of such methods are performed by the computer system 900 in response to processor 904 executing one or more sequences of one or more instructions (which might be incorporated into the operating system 916 and/or other code, such as an application program 918) contained in the working memory 914. Such instructions may be read into the working memory 914 from another computer-readable medium, such as one or more of the storage device(s) 910. Merely by way of example, execution of the sequences of instructions contained in the working memory 914 may cause the processor(s) 904 to perform one or more procedures of the methods described herein.

The terms “machine-readable medium” and “computer-readable medium,” as used herein, may refer to any non-transitory medium that participates in providing data that causes a machine to operate in a specific fashion. In an example implemented using the computer device 900, various computer-readable media might be involved in providing instructions/code to processor(s) 904 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 910. Volatile media may include, without limitation, dynamic memory, such as the working memory 914.

Example forms of physical and/or tangible computer-readable media may include a floppy disk, a flexible disk, hard disk, magnetic tape, or any other magnetic medium, a compact disc, any other optical medium, ROM (Read Only Memory), RAM (Random Access Memory), and etc., any other memory chip or cartridge, or any other medium from which a computer may read instructions and/or code. Various forms of computer-readable media may be involved in carrying one or more sequences of one or more instructions to the processor(s) 904 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 900.

The communications subsystem 912 (and/or components thereof) generally will receive signals, and the bus 902 then might carry the signals (and/or the data, instructions, etc. carried by the signals) to the working memory 914, from which the processor(s) 904 retrieves and executes the instructions. The instructions received by the working memory 914 may optionally be stored on a non-transitory storage device 910 either before or after execution by the processor(s) 904. It should further be understood that the components of computer device 900 can be distributed across a network. For example, some processing may be performed in one location using a first processor while other processing may be performed by another processor remote from the first processor. Other components of computer system 900 may be similarly distributed. As such, computer device 900 may be interpreted as a distributed computing system that performs processing in multiple locations. In some instances, computer system 900 may be interpreted as a single computing device, such as a distinct laptop, desktop computer, or the like, depending on the context.

The methods, systems, and devices discussed above are examples. Various configurations may omit, substitute, or add various method steps or procedures, or system components as appropriate. For instance, in alternative configurations, the methods may be performed in an order different from that described, and/or various stages or steps or modules may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example examples described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An event notification detection and display system comprising:
a network interface configured to receive sensor data from one or more sensor devices of a home automation system;
a processing unit comprising one or more processors;
memory coupled with and readable by the processing unit and storing therein a set of instructions which, when executed by the processing unit, causes the event notification detection and display system to:
receive sensor data from a first sensor device of a home automation system, the sensor data indicative of a first event detected by the first sensor device;
determine a first display device associated with the home automation system on which to display a notification corresponding to the first event;
identify first content being displayed on the first display device concurrently with the receiving of the indication of the first event;
monitor the display of the first content on the first display device;
during the monitoring, detect a change in the first content being displayed on the first display device; and
in response to the detection of the change in the first content being displayed on the first display device, output a notification via the first display device corresponding to the first event detected by the first sensor device.

2. The event notification detection and display system of claim 1, wherein the first content being displayed on the first display device comprises a television programming stream received via a television signal transmitted by a headend, and wherein detecting the change in the television programming stream comprises:
detecting an indicator embedded within the television signal transmitted by the headend, the indicator identifying one or more television advertisements contained within the television programming stream.

3. The event notification detection and display system of claim 1, wherein the first content being displayed on the first display device comprises at least one of a prerecorded television program, a movie, or a video game displayed via a gaming console, and wherein the first content is stored within a local storage media or local storage device at the event notification detection and display system.

4. The event notification detection and display system of claim 1, the memory storing therein further instructions which, when executed by the processing unit, causes the event notification detection and display system to:
prior to outputting the notification via the first display device, output an initial notification via the first display device corresponding to the first event detected by the first sensor device, wherein the initial notification is output in response to the received indication of the first event; and
receive a user response to the initial notification, the user response corresponding to a user request to display a subsequent notification at a later time.

5. The event notification detection and display system of claim 1, wherein detecting the change in the first content being displayed on the first display device comprises detecting a user input received via a controller device of the first display device.

6. The event notification detection and display system of claim 5, wherein the user input received via the controller device corresponds to an instruction to change the channel or the data source being displayed on the first display device, and
wherein the notification of the first event detected by the first sensor device is output via the first display device, in response to the instruction to change the channel or the data source displayed on the first display device.

7. The event notification detection and display system of claim 5, wherein the user input received via the controller device corresponds to an instruction to turn off the first display device, and wherein outputting the notification via the first display device comprises:
determining that the first display device is turned off and is incapable of displaying the notification; and
determining a second display associated with the home automation system on which to display the notification corresponding to the first event.

8. The event notification detection and display system of claim 1, the memory storing therein further instructions which, when executed by the processing unit, causes the event notification detection and display system to:
in response to receiving the sensor data indicative of the first event detected by the first sensor device, determine a corresponding notification priority level associated with the first event; and
based on the determined notification priority level associated with the first event, determine that a delayed notification and not an immediate notification should be output.

9. The event notification detection and display system of claim 8, wherein the determination of the notification priority level associated with the first event is based on the first sensor device that detected the first event, and a time associated with the first event.

10. A method, comprising:
receiving, by a notification system, sensor data from a first sensor device of a home automation system, the sensor data indicative of a first event detected by the first sensor device;
determining, by the notification system, a first display device associated with the home automation system on which to display a notification corresponding to the first event;
identifying, by the notification system, first content being displayed on the first display device concurrently with the receiving of the indication of the first event;
monitoring, by the notification system, the display of the first content on the first display device;
detecting, by the notification system, a change in the first content being displayed on the first display device during the monitoring; and
outputting, by the notification system, a notification via the first display device corresponding to the first event detected by the first sensor device, in response to the detection of the change in the first content being displayed on the first display device.

11. The method of claim 10, wherein the first content being displayed on the first display device comprises a television programming stream received via a television signal transmitted by a headend, and wherein detecting the change in the television programming stream comprises:
detecting an indicator embedded within the television signal transmitted by the headend, the indicator identifying one or more television advertisements contained within the television programming stream.

12. The method of claim 10, wherein the first content being displayed on the first display device comprises at least one of a prerecorded television program, a movie, or a video game displayed via a gaming console, and wherein the first content is stored within a local storage media or local storage device at the notification system.

13. The method of claim 10, further comprising:
prior to outputting the notification via the first display device, outputting an initial notification via the first display device corresponding to the first event detected by the first sensor device, wherein the initial notification is output in response to the received indication of the first event; and
receiving a user response to the initial notification, the user response corresponding to a user request to display a subsequent notification at a later time.

14. The method of claim 10, wherein detecting the change in the first content being displayed on the first display device comprises detecting a user input received via a controller device of the first display device.

15. The method of claim 14, wherein the user input received via the controller device corresponds to an instruction to change the channel or the data source being displayed on the first display device, and
wherein the notification of the first event detected by the first sensor device is output via the first display device, in response to the instruction to change the channel or the data source displayed on the first display device.

16. The method of claim 14, wherein the user input received via the controller device corresponds to an instruction to turn off the first display device, and wherein outputting the notification via the first display device comprises:
determining that the first display device is turned off and is incapable of displaying the notification; and
determining a second display associated with the home automation system on which to display the notification corresponding to the first event.

17. The method of claim 1, further comprising:
in response to receiving the sensor data indicative of the first event detected by the first sensor device, determining a corresponding notification priority level associated with the first event; and
based on the determined notification priority level associated with the first event, determining that a delayed notification and not an immediate notification should be output.

18. The method of claim 17, wherein the determination of the notification priority level associated with the first event is based on the first sensor device that detected the first event, and a time associated with the first event.

19. A non-transitory computer-readable memory comprising a set of instructions stored therein which, when executed by a processor, causes the processor to:
receive sensor data from a first sensor device of a home automation system, the sensor data indicative of a first event detected by the first sensor device;
determine a first display device associated with the home automation system on which to display a notification corresponding to the first event;
identify first content being displayed on the first display device concurrently with the receiving of the indication of the first event;
monitor the display of the first content on the first display device;
during the monitoring, detect a change in the first content being displayed on the first display device; and
in response to the detection of the change in the first content being displayed on the first display device, output a notification via the first display device corresponding to the first event detected by the first sensor device.

20. The non-transitory computer-readable memory of claim 19, wherein the first content being displayed on the first display device comprises a television programming stream received via a television signal transmitted by a headend, and wherein detecting the change in the television programming stream comprises:
detecting an indicator embedded within the television signal transmitted by the headend, the indicator identifying one or more television advertisements contained within the television programming stream.
